(19) United States
(12) Patent Application Publication
(10) Pub. No.: US 2025/0234375 A1
(43) Pub. Date: Jul. 17, 2025

(54) ACCESS POINT (AP)-AIDED DOWNLINK TRANSMISSION OPPORTUNITY (TXOP) PREEMPTION BY STATIONS (STAS) WITH LOW-LATENCY UPLINK TRAFFIC

(71) Applicant: QUALCOMM Incorporated, San Diego, CA (US)

(72) Inventors: George CHERIAN, San Diego, CA (US); Alfred ASTERJADHI, San Diego, CA (US); Abhishek Pramod PATIL, San Diego, CA (US); Sai Yiu Duncan HO, San Diego, CA (US); Gaurang NAIK, San Diego, CA (US); Sanket Sanjay Kalamkar, San Diego, CA (US); Giovanni Chisci, San Diego, CA (US); Sherief Helwa, San Diego, CA (US)

(21) Appl. No.: 18/412,920

(22) Filed: Jan. 15, 2024

(51) Int. Cl. H04W 74/0808; H04W 72/56

(52) U.S. Cl. CPC H04W 74/0808; H04W 72/56

(57) ABSTRACT

This disclosure provides methods, components, devices and systems for access point (AP)-aided downlink transmission opportunity (TXOP) preemption by stations (STAs) with low-latency uplink traffic. Some aspects more specifically relate to how a STA transmits a preemption indication (PRI) associated with a signature of the STA and how an AP, via reception of signature-based PRIs, may obtain information relating to which specific STAs have low-latency traffic ready for uplink transmission. Such signatures may relate to a resource allocation, such as a tone pattern, used to transmit at least a portion of a PRI. In some examples, the AP transmits a preemption scheduling (PRS) frame that includes channel access information, for each of the STA(s) that sent a PRI, associated with a downlink TXOP of the AP. Such channel access information may include at least a grant of permission for STA(s) to attempt uplink preemption of the downlink TXOP.

### TECHNICAL FIELD

This disclosure relates generally to wireless communication and, more specifically, to access point (AP)-aided downlink transmission opportunity (TXOP) preemption by stations (STAs) with low-latency uplink traffic.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless station (STA). The wireless STA may include a processing system that includes processor circuitry and memory circuitry that stores code. The processing system may be configured to cause the wireless STA to transmit a preemption indication associated with a signature of the wireless STA and receive, in accordance with the preemption indication being associated with the signature of the wireless STA, a frame that includes channel access information, for the wireless STA, associated with a downlink transmission opportunity (TXOP) of a wireless access point (AP).

Another innovative aspect of the subject matter described in this disclosure can be implemented in a method for wireless communication by a wireless STA. The method may include transmitting a preemption indication associated with a signature of the wireless STA and receiving, in accordance with the preemption indication being associated with the signature of the wireless STA, a frame that includes channel access information, for the wireless STA, associated with a downlink TXOP of a wireless AP.

Another innovative aspect of the subject matter described in this disclosure can be implemented in a wireless STA. The wireless STA may include means for transmitting a preemption indication associated with a signature of the wireless STA and means for receiving, in accordance with the preemption indication being associated with the signature of the wireless STA, a frame that includes channel access information, for the wireless STA, associated with a downlink TXOP of a wireless AP.

Another innovative aspect of the subject matter described in this disclosure can be implemented in a non-transitory computer-readable medium storing code for wireless communication by wireless STA. The code may include instructions executable by a processing system to transmit a preemption indication associated with a signature of the wireless STA and receive, in accordance with the preemption indication being associated with the signature of the wireless STA, a frame that includes channel access information, for the wireless STA, associated with a downlink TXOP of a wireless AP.

Some examples of the method, wireless STAs, and non-transitory computer-readable medium described herein may further include operations, features, means, or instructions for transmitting at least a portion of the preemption indication via a physical layer (PHY) protocol data unit (PPDU) sent using the resource allocation associated with the wireless STA, where the signature of the wireless STA is included in the resource allocation.

In some examples of the method, wireless STAs, and non-transitory computer-readable medium described herein, at least the portion of the preemption indication includes a field of a preamble of the PPDU that carries the preemption indication and the resource allocation includes a tone pattern specific to the wireless STA.

Some examples of the method, wireless STAs, and non-transitory computer-readable medium described herein may further include operations, features, means, or instructions for transmitting an indication of a priority value associated with uplink data at the wireless STA via the preemption indication, where the channel access information may be associated with the priority value.

In some examples of the method, wireless STAs, and non-transitory computer-readable medium described herein, the channel access information includes an indication that the wireless STA may be allowed to preempt the downlink TXOP.

In some examples of the method, wireless STAs, and non-transitory computer-readable medium described herein, the frame includes one or more STA info subfields, each respective STA info subfield of the one or more STA info subfields applicable to a respective wireless STA that transmitted a respective preemption indication associated with a respective signature and the one or more STA info subfields include a first STA info subfield that corresponds to the wireless STA and includes the channel access information.

In some examples of the method, wireless STAs, and non-transitory computer-readable medium described herein, the frame includes a common info subfield, the common info subfield applicable to a set of wireless STAs that transmitted preemption indications associated with signatures and the common info subfield includes the channel access information.

Another innovative aspect of the subject matter described in this disclosure can be implemented in a wireless AP. The wireless AP may include a processing system that includes processor circuitry and memory circuitry that stores code. The processing system may be configured to cause the wireless AP to receive a preemption indication associated with a signature of a wireless STA and transmit, in accordance with the preemption indication being associated with the signature of the wireless STA, a frame that includes channel access information, for the wireless STA, associated with a downlink TXOP of the wireless AP.

Another innovative aspect of the subject matter described in this disclosure can be implemented in a method for wireless communication by a wireless AP. The method may include receiving a preemption indication associated with a signature of a wireless STA and transmitting, in accordance with the preemption indication being associated with the signature of the wireless STA, a frame that includes channel access information, for the wireless STA, associated with a downlink TXOP of the wireless AP.

Another innovative aspect of the subject matter described in this disclosure can be implemented in a wireless AP. The wireless AP may include means for receiving a preemption indication associated with a signature of a wireless STA and means for transmitting, in accordance with the preemption indication being associated with the signature of the wireless STA, a frame that includes channel access information, for the wireless STA, associated with a downlink TXOP of the wireless AP.

Another innovative aspect of the subject matter described in this disclosure can be implemented in a non-transitory computer-readable medium storing code for wireless communication by a wireless AP. The code may include instructions executable by one or more processors to receive a preemption indication associated with a signature of a wireless STA and transmit, in accordance with the preemption indication being associated with the signature of the wireless STA, a frame that includes channel access information, for the wireless STA, associated with a downlink TXOP of the wireless AP.

Some examples of the method, wireless APs, and non-transitory computer-readable medium described herein may further include operations, features, means, or instructions for receiving a set of multiple preemption indications including the preemption indication, where each respective preemption indication of the set of multiple preemption indications may be associated with a respective signature of a respective wireless STA such that the set of multiple preemption indications may be associated with a set of multiple signatures of a set of multiple wireless STAs including the wireless STA and transmitting the frame that includes the channel access information in accordance with the set of multiple preemption indications being associated with the set of multiple signatures.

Some examples of the method, wireless APs, and non-transitory computer-readable medium described herein may further include operations, features, means, or instructions for receiving at least a portion of the preemption indication via a PPDU sent using the resource allocation associated with the wireless STA, where the signature of the wireless STA is included in the resource allocation.

In some examples of the method, wireless APs, and non-transitory computer-readable medium described herein, at least the portion of the preemption indication includes a field of a preamble of the PPDU that carries the preemption indication and the resource allocation includes a tone pattern specific to the wireless STA.

Some examples of the method, wireless APs, and non-transitory computer-readable medium described herein may further include operations, features, means, or instructions for receiving an indication of a priority value associated with uplink data at the wireless STA via the preemption indication, where the channel access information may be associated with the priority value.

In some examples of the method, wireless APs, and non-transitory computer-readable medium described herein, the channel access information includes an indication that the wireless STA may be allowed to preempt the downlink TXOP.

In some examples of the method, wireless APs, and non-transitory computer-readable medium described herein, the frame includes one or more STA info subfields, each respective STA info subfield of the one or more STA info subfields applicable to a respective wireless STA that transmitted a respective preemption indication associated with a respective signature and the one or more STA info subfields include a first STA info subfield that corresponds to the wireless STA and includes the channel access information.

In some examples of the method, wireless APs, and non-transitory computer-readable medium described herein, the frame includes a common info subfield, the common info subfield applicable to a set of wireless STAs that transmitted preemption indications associated with signatures and the common info subfield includes the channel access information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) PDU (PPDU) usable for communications between a wireless AP and one or more wireless STAs.

FIG. 4 shows a frequency diagram depicting an example distributed tone mapping.

FIG. 5 shows an example signaling diagram that supports AP-aided downlink transmission opportunity (TXOP) preemption by STAs with low-latency uplink traffic.

FIGS. 6-9 show example communication timelines that support AP-aided downlink TXOP preemption by STAs with low-latency uplink traffic.

FIG. 10 shows an example process flow that supports AP-aided downlink TXOP preemption by STAs with low-latency uplink traffic.

FIG. 11 shows a block diagram of an example wireless communication device that supports AP-aided downlink TXOP preemption by STAs with low-latency uplink traffic.

FIG. 12 shows a block diagram of an example wireless communication device that supports AP-aided downlink TXOP preemption by STAs with low-latency uplink traffic.

FIGS. 13 and 14 show flowcharts illustrating example processes performable by or at a STA that supports AP-aided downlink TXOP preemption by STAs with low-latency uplink traffic.

FIGS. 15 and 16 show flowcharts illustrating example processes performable by or at a wireless AP that supports AP-aided downlink TXOP preemption by STAs with low-latency uplink traffic.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to signature-based preemption indications (PRIs). Some aspects more specifically relate to how a station (STA) may transmit a PRI associated with a signature of the STA and how an access point (AP), via reception of one or more signature-based PRIs, may obtain (such as identify, detect, learn, determine, or otherwise collect) information relating to which specific STAs have latency sensitive traffic ready for uplink transmission. In some examples, the AP may identify (such as learn, understand, or otherwise determine) which specific STAs sent a PRI in accordance with parsing each received PRI for a specific signature, each signature corresponding to a respective STA. Such signatures may relate to a resource allocation, such as a tone pattern, used to transmit at least a portion of a PRI (such as at least a portion of a physical layer (PHY) protocol data unit (PPDU) carrying the PRI). For example, a signature may be associated with a tone pattern of one or more long training fields (LTFs) of a PPDU carrying the PRI. In such examples, a first LTF tone pattern may correspond to a first STA and a second LTF tone pattern may correspond to a second STA.

In accordance with receiving one or more PRIs from one or more STAs and obtaining information indicative of which specific STAs have latency sensitive traffic ready for uplink transmission via the signature(s) of the PRI(s), the AP may transmit a preemption scheduling (PRS) frame that includes channel access information, for each of the STA(s) that sent a PRI, associated with a downlink transmission opportunity (TXOP) of the AP. Such channel access information may include a grant of permission to attempt uplink preemption of the downlink TXOP or one or more channel access parameters according to which the permitted STA(s) may attempt to obtain channel access. In some implementations, the PRS frame may include a 1-bit indication that a set of (such as all) PRI-transmitting STAs are allowed to attempt uplink preemption. Additionally, or alternatively, the PRS frame may include multiple fields or subfields, each field or subfield providing channel access information associated with a specific STA.

Particular aspects of the subject matter described in this disclosure can be implemented to realize one or more of the following potential advantages. In some examples, by supporting the use of signature-based PRIs, the described techniques can be used to enable an AP to obtain information indicative of which specific STA(s) are requesting uplink preemption and use such information to control which STA(s) are permitted (such as allowed) to attempt uplink preemption or how such permitted STA(s) can attempt to obtain channel access. By having control over which STA(s) are permitted to attempt uplink preemption, the AP may be able to prioritize specific STA(s) or specific latency sensitive traffic over other STA(s) or other latency sensitive traffic, which the AP may use to achieve more suitable or fair channel access sharing with its associated STAs. For example, the AP may use such control over uplink preemption to reduce the likelihood that a given STA is too often outcompeted for channel access despite having relatively higher priority latency sensitive traffic as compared to another STA, or to increase the likelihood that two STAs with approximately equal priority latency sensitive traffic experience relatively similar channel access time (such as approximately the same amount of channel access time). In other words, the AP may use such control over uplink preemption to achieve lower or more predictable latency for high priority or latency sensitive traffic types. Additionally, by supporting the use of signature-based PRIs and the related signaling mechanisms, the described techniques can be used to reduce signaling overhead associated with polling or enhanced distributed channel access (EDCA), which may increase overall medium efficiency. For example, an AP may refrain from individually polling STAs that transmit a signature-based PRI (as the AP may obtain information related to buffered uplink traffic at such STAs by way of receiving the signature-based PRIs from those STAs). For further example, in accordance with obtaining channel access using information provided via a PRS frame, fewer STAs may attempt to gain channel access via EDCA at a given time.

Further, in accordance with the various PRS frame designs described in this disclosure, the AP and the preempting STA(s) may achieve or facilitate such AP control while maintaining relatively low signaling overhead (such as via a 1-bit indication in a PRS frame) or by enabling more granular (per-STA) signaling of channel access information (such as via one or more fields or subfields of the PRS frame each providing channel access information to a respective preempting STA). Moreover, by supporting or indicating information associated with one or more of various channel access policies during a preemption duration of the downlink TXOP, the AP and the preempting STA(s) may avoid ambiguity relating to how or when STAs are expected to contend for channel access during the preemption duration. Such a reduction in ambiguity may provide power savings at the preempting STA(s), fewer channel collisions, or less or more predictable channel contention. In accordance with lower or more predictable latency and less ambiguity (such as uncertainty) relating to channel access, aspects of the subject matter described in this disclosure can be further implemented to realize higher data rates, greater system capacity, greater spectral efficiency, and improved user experiences, among other benefits.

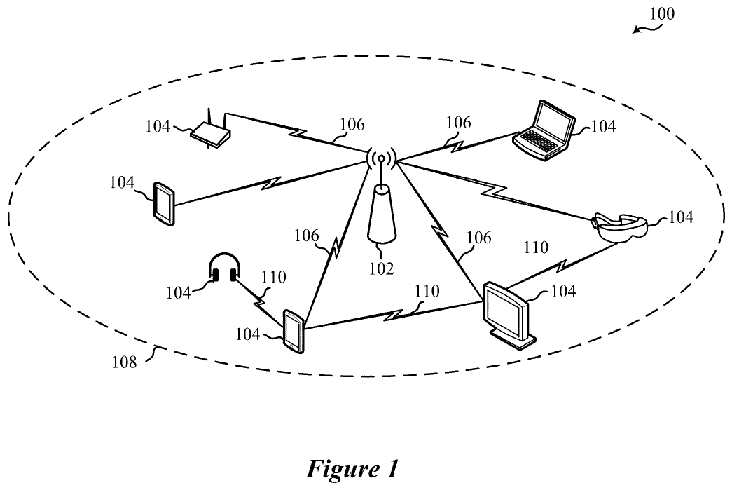

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 MHZ, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

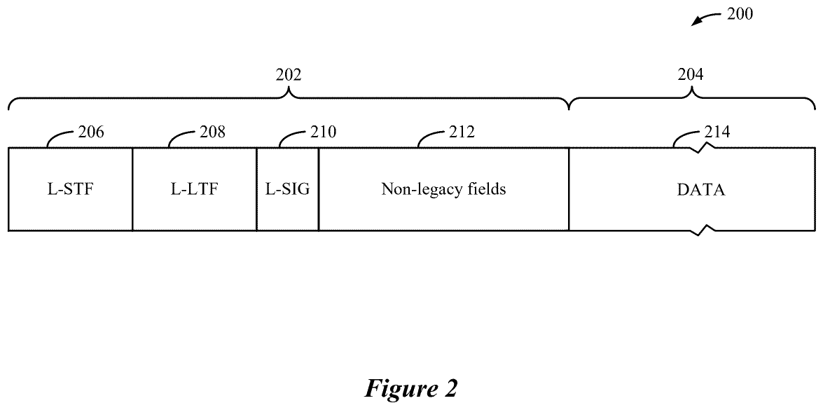

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

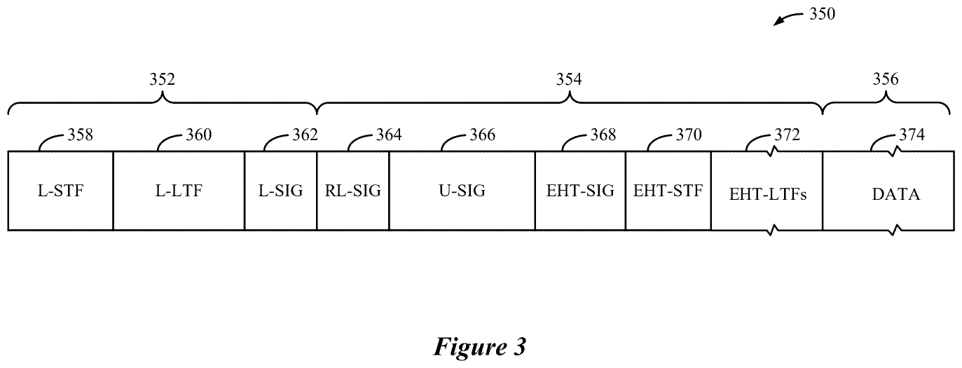

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

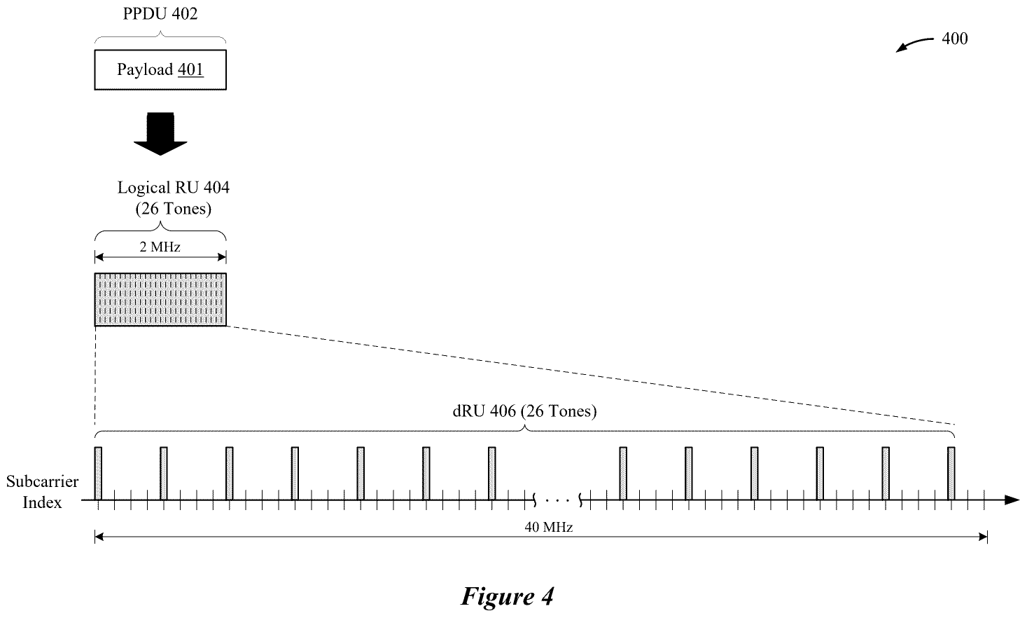

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHz subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHZ, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

In accordance with some of the examples disclosed herein, an AP 102 and a STA 104 may support a signature-based PRI signaling mechanism according to which the STA 104 may transmit a PRI (an indication that the STA 104 has latency sensitive uplink traffic ready for uplink transmission) that identifies the STA 104 to the AP 102 (via the signature). Such a signature may be associated with (such as included in) a resource allocation of a portion of the PRI. In some examples, the portion of the PRI may be an LTF of a PPDU carrying the PRI, such as the L-LTF 208, the L-LTF 360, or the EHT-LTF 372 as illustrated by and described with reference to FIGS. 2 and 3. Further, the resource allocation that includes the signature may be or include a tone pattern (such as a pattern of subcarrier indices across a range of subcarrier indices, as illustrated by FIG. 4), such that the tone pattern (of the LTF of the PPDU carrying the PRI) identifies the STA 104 to the AP 102. In accordance with identifying the STA 104, the AP 102 may transmit a PRS frame to the STA 104 providing channel access information, for the STA 104, associated with a downlink TXOP of the AP 102.

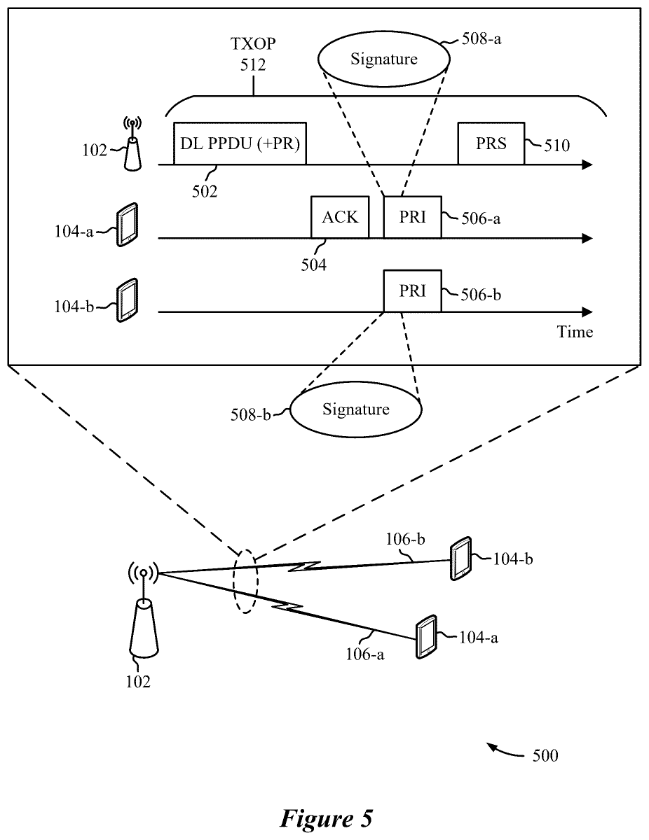

FIG. 5 shows an example signaling diagram 500 that supports AP-aided downlink TXOP preemption by STAs with low-latency uplink traffic. The signaling diagram 500 may implement or be implemented to realize one or more aspects of the wireless communication network 100, the PDU 200, the PPDU 350, or the frequency diagram 400. For example, the signaling diagram 500 illustrates communication between an AP 102, a STA 104-a, and a STA 104-b, which may be examples of an AP 102 or a STA 104 as illustrated by or described with reference to FIGS. 1-4.

In some aspects, the signaling diagram 500 may support latency sensitive traffic (such as by reducing latency or providing relatively predictable latency). Latency sensitive traffic (which may be equivalently referred to as low-latency traffic or low-latency packets) may be classified into different types including periodic traffic and aperiodic traffic. Periodic traffic may be associated with a predictable traffic arrival and aperiodic traffic may be associated with an unpredictable traffic arrival. To support periodic/predictable latency sensitive traffic, an AP 102 may employ coordinated AP techniques, such as coordinated TDMA (C-TDMA) or coordinated restricted target wake time (TWT) (C-rTWT). To support aperiodic/unpredictable latency sensitive traffic, an AP 102 may allow for or enable preemption, such as an uplink preemption of a downlink TXOP 512. Without preemption, when a latency sensitive packet arrives, a wireless communication device (such as an AP 102 or a STA 104) may be expected to wait until an end of an ongoing TXOP before transmitting the latency sensitive packet. With preemption, a wireless communication device may “preempt” (such as take over a wireless medium or transmission opportunity from) another wireless communication device to transmit a latency sensitive packet.

In some networks, one or more wireless communication devices (such as one or more APs 102 or one or more STAs 104) may support a short downlink PPDU, which may enable or otherwise facilitate downlink TXOP preemption (such as to enable or facilitate a STA to try to preempt for an uplink transmission). A short downlink PPDU may be a PPDU that spans a relatively shorter duration as compared to some other PPDUs. Accordingly, a sequence of multiple short downlink PPDUs may provide more preemption opportunities as compared to a single relatively longer PPDU, as a time gap between two short downlink PPDUs may enable a STA to attempt uplink preemption (which may not be possible during the relatively longer PPDU).

To facilitate uplink preemption, wireless communication devices may support signaling mechanisms including preemption allowed (PR) messages from an AP 102 and preemption indication (PRI) messages (which may equivalently be referred to as preemption traffic indication messages) from one or more STAs 104. A PR message may be a broadcast frame and a PRI message may be sent in accordance with an uplink MU OFDMA communication scheme. In accordance with such signaling mechanisms, a PR message may enable preemption of a downlink TXOP 512 for a STA 104 with which the AP 102 is communicating and the STA 104 may transmit a PRI to signal an intention of the STA 104 to preempt the downlink TXOP 512. The AP 102 may defer (such as delay, skip, postpone, or re-schedule) the next downlink PPDU, which may be scheduled for point coordination function (PCF) inter-frame space (PIFS) after an end of a previous downlink PPDU or a related acknowledgment (ACK), if the AP 102 receives a PRI within a short inter-frame space (SIFS) after the previous downlink PPDU or the related ACK. In some aspects, a PRI message may piggyback with an ACK (such as be multiplexed with an ACK in the frequency domain). In some other aspects, a wireless communication device may transmit a PRI message as a separate frame SIFS after the ACK.

Such signaling mechanisms, however, may lack identifying elements. Thus, after a PRI message transmission, any STA 104 with low-latency traffic may contend to preempt the downlink TXOP 512 and an AP 102 may lack a mechanism to control which STA(s) 104 can participate, to control access (such as to provide one or more per-STA parameters), or to prioritize one or more STAs 104. In other words, while an AP 102 may indicate when uplink preemption is allowed during a TXOP of the AP 102, the AP 102 may lack a mechanism via which to control which or how STA(s) 104 are able to obtain channel access during the TXOP (because the AP 102 may not know which specific STA(s) 104 sent a PRI message). Such a lack of a mechanism via which to control which or how STA(s) 104 are able to obtain channel access during the TXOP may result in a STA 104 with relatively higher priority latency sensitive traffic being outcompeted for channel access by a STA 104 with relatively lower priority latency sensitive traffic or an unequal share of channel access between STAs 104 with approximately equal priority latency sensitive traffic. Such and other similar scenarios may be associated with poor/unpredictable traffic delivery and user experience. Further, such and other similar scenarios may arise relatively more often in dense deployment scenarios, which may be increasingly common as more devices support wireless communication (such as Wi-Fi) capabilities.

In some implementations, an AP 102 may obtain more control over which or how STA(s) 104 are able to preempt a downlink TXOP 512 via a signature-based PRI. In some examples, the AP 102 may send a PR message to poll one or more STAs 104 (such as the STA 104-a and the STA 104-b) on whether any of the one or more STAs 104 have latency sensitive traffic (such as traffic that is eligible for uplink preemption). The AP 102 may transmit such a PR message via a downlink PPDU 502 (shown as “DL PPDU” in some of the example Figures). The AP 102 may transmit the downlink PPDU 502 via a communication link 106-a or communication link 106-b to the STA 104-a or the STA 104-b, respectively.

In some aspects, the AP 102 may transmit, indicate, or otherwise provide the PR message via or as a poll or as a request for PRI(s). For example, the AP 102 may send the PR message as a Trigger frame (within the downlink PPDU 502), such as a null data packet (NDP) feedback report poll (NFRP). In other words, the PR message may be an NFRP trigger frame multiplexed within the downlink PPDU 502. The NFRP may target one or more STAs 104 (such as the STA 104-a and the STA 104-b) to poll such one or more STAs 104 for PRI(s). In some aspects, the NFRP may target one or more STAs 104 in accordance with indicating a starting association identifier (AID) and a range (such as a range of AID values). In some examples, the NFRP may enable detection of an identity of a STA 104 even if NDP feedback reports (NFRs) are transmitted via common resources (such as resources available for use by multiple STAs 104, as opposed to resources that are only available to a single STA 104).

The AP 102 may use one of a set of codepoints from a field in a user info field of the NFRP for PRI polling for low-latency preemption. For example, the AP 102 may use one of a set of codepoints (such as one of a set of 15 left, remaining, or available codepoints) from a 4-bit feedback type field in the user info field to indicate PRI polling for low-latency preemption. Additionally, or alternatively, the AP 102 may include the PR message (which may be equivalently referred to as a PR indication) via a PHY header or a MAC frame header. For example, the AP 102 may piggyback the PR message with the downlink PPDU or may use a short control frame (such as with a special receiver address (RA), and such as a request-to-send (RTS) or clear-to-send (CTS) frame) to indicate the PR message. Such piggybacking of the PR message with the downlink PPDU or the use of a short control frame may be associated with relatively lower signaling overhead.

In accordance with transmission of the downlink PPDU 502 including the PR message from the AP 102, any STA 104 that has latency sensitive traffic may signal (such as indicate) the presence of latency sensitive traffic to the AP 102 via a PRI message (which may be equivalently referred to as a PRI or preemption indication). In some implementations, a STA 104 may indicate that the STA 104 has latency sensitive traffic by transmitting a PRI message associated with (or otherwise in accordance with) a signature of the STA 104. In other words, any STA 104 that is interested in preempting the downlink TXOP 512 can signal such interest to the AP 102 on a dedicated resource (such as a resource dedictated to PRI signaling or dedicated to a specific STA 104) by using a PRI with signature.

Such a signature of a STA 104 may relate to any information or resource usage that can identify (such as distinguish to the AP 102) the STA 104 from a group of STAs 104. For example, in accordance with receiving the downlink PPDU 502 indicating the PR message, the STA 104-a may transmit a PRI 506-a associated with a signature 508-a, with the signature 508-a being associated with (such as identifying) the STA 104-a from other STAs 104. Similarly, the STA 104-b may transmit a PRI 506-b associated with a signature 508-b, with the signature 508-b being associated with (such as identifying) the STA 104-b from other STAs 104. In some aspects, transmission of the PRI 506-a or the PRI 506-b may start a preemption phase of the downlink TXOP 512.

In some implementations, a signature of a STA 104 may be associated with, based on, include, or included within a resource allocation associated with the STA 104. Such a resource allocation may be a tone pattern, such as a STA-specific tone pattern (including, for example, a tone pattern associated with an RU, such as a logical RU 404 or a dRU 406 as illustrated by and described with reference to FIG. 4, or any other pattern of tones across a given bandwidth). For example, the signature 508-a may be associated with, based on, or include a first resource allocation (such as a first tone pattern) associated with the STA 104-a. For further example, the signature 508-b may be associated with, based on, or include a second resource allocation (such as a second tone pattern) associated with the STA 104-b. In some aspects, a STA 104 may transmit at least a portion of a PRI via the resource allocation associated with the STA 104. In other words, a STA 104 may transmit at least a portion of a PRI via a PPDU sent using the resource allocation associated with the STA 104.

Such a portion of the PRI may include a field of a preamble of the PPDU that carries the PRI, such as an LTF of the preamble of the PPDU (as a PRI may include both a preamble portion and a data portion). For example, an LTF may include or be associated with a sequence of tones and may be understood as being split in time. Accordingly, an LTF may be conveyed via one or more time-frequency resources of a time-frequency resource grid, where each time-frequency unit (or each set of (contiguous or non-contiguous) time-frequency units) may be assigned to a different STA 104. Thus, a STA-specific tone pattern (a signature of a STA 104) may be a time-frequency resource, or a set of (contiguous or non-contiguous) time-frequency resources, that uniquely identify a STA 104. Additionally, or alternatively, a signature of a STA 104 may be understood as a tone configuration of the STA 104, such that a tone configuration of each STA 104 may be a response signature associated with a PRI. Such an LTF may be an example of the L-LTF 208, the L-LTF 360, or the EHT-LTF 372 as illustrated by and described with reference to FIGS. 2 and 3.

For example, the AP 102 may assign (such as via signaling, such as via a beacon frame or other management frame, or via a mutually understood rule) the STA 104-a to a first time-frequency unit (such that the signature 508-a of the STA 104-a is associated with the first time-frequency unit) and may assign the STA 104-b to a second time-frequency unit (such that the signature 508-b of the STA 104-b is associated with the second time-frequency unit) different from the first time-frequency unit. In such examples, the STA 104-a may transmit (and place RF energy) on the first time-frequency unit and refrain from transmitting via any other of the time-frequency units (such as via any other frequencies or slots) of the grid of time-frequency units to indicate that the STA 104-a has latency sensitive traffic ready for uplink transmission and to uniquely identify the STA 104-a to the AP 102. For example, the STA 104-a may transmit its LTF sequence via the first time-frequency unit. In an example of an 80 MHz bandwidth that spans 16 microseconds, the 80 MHz bandwidth may include 40 different 2 MHz portions and the 16 microseconds may include a first time span of 8 microseconds and a second time span of 8 microseconds, and each combination of a 2 MHz portion and an 8 microsecond time span may correspond to a respective time-frequency unit. In some aspects, other STAs 104 that do not have latency sensitive traffic ready for uplink transmission also may transmit a PRI, but may refrain from applying energy to any time-frequency unit within the grid of time-frequency units (the grid of time-frequency units associated with indicating the presence of latency sensitive traffic and associated with identifying the transmitting STA 104).

Additionally, or alternatively, the STA 104-a may encode a bit value (such as 1 or 0) to the first time-frequency unit, where transmission via the first time-frequency unit uniquely identifies the STA 104-a to the AP 102, and where the bit value indicates whether the STA 104-a has latency sensitive traffic ready for uplink transmission. For example, a bit value of 1 may indicate that the STA 104-a has latency sensitive traffic ready for uplink transmission and a bit value of 0 may indicate that the STA 104-a does not have latency sensitive traffic ready for uplink transmission. In any of such implementations, the AP 102 may be able to decode the received PRIs and identify which specific STAs 104 have latency sensitive traffic ready for uplink transmission in accordance with on which time-frequency units, of the grid of time-frequency units, RF energy is present.

In some aspects, a STA 104 with latency sensitive traffic (such as low-latency traffic) may send a PRI with signature SIFS after another transmission, without a triggering NFRP. In other words, the AP 102 may optionally transmit a PR message and a STA 104 may transmit a PRI with or without a prior reception of a PR message. In some examples, a STA 104 may transmit a PRI SIFS after the downlink PPDU 502 (which may include/indicate or not include/indicate the PR message). In such examples, the STA 104 may transmit the PRI SIFS after the downlink PPDU 502 if feedback (such as ACK) is not requested by the downlink PPDU 502 or may multiplex the PRI with the feedback. For example, the STA 104-a may, in some implementations, multiplex the PRI 506-a with an ACK 504, the ACK 504 being associated with (such as responsive to or providing feedback regarding) the downlink PPDU 502. In some other examples, a STA 104 may transmit a PRI after (such as SIFS after) feedback related to the downlink PPDU 502. For example, the STA 104-a and the STA 104-b may transmit the PRI 506-a and the PRI 506-b after (such as SIFS after) the ACK 504 associated with the downlink PPDU 502. In other words, a PRI opportunity (such as a PRI transmission opportunity) may be SIFS after the downlink PPDU 502 if ACK is not requested or may be SIFS after the ACK 504 to the downlink PPDU 502 otherwise.

In some implementations, a PRI may exclusively include or otherwise be associated with a STA-specific signature (such as exclusively a STA-specific tone pattern for an NFR). For example, the PRI 506-a may exclusively include or otherwise be associated with the signature 508-a of the STA 104-a. In some other implementations, a PRI may include or otherwise be associated with a STA-specific signature and additional information, such as information indicative of a priority (such as a priority value). For example, the PRI 506-a may include or otherwise be associated with the signature 508-a of the STA 104-a and may additionally indicate a priority. In such implementations, a PRI may indicate a priority value from a set of low-latency priorities specifically defined for uplink preemption. Additionally, or alternatively, a PRI may indicate a priority value by way of indicating a user priority (UP). Additionally, or alternatively, a priority value may correspond to an application type or a quality of service (QOS) class, which may in turn correspond to or be associated with (such as translated or mapped to) channel access information provided by the AP 102. Thus, a priority value may be associated with the STA 104-a, a user of the STA 104-a, or an application of or traffic at the STA 104-a. In some aspects, each UP of a set of UPs may map to a respective traffic class. Additionally, or alternatively, a PRI may be an NFR frame. In such examples, a tone pattern of the NFR frame may correspond to (such as be mapped to) an AID of a corresponding STA 104. For example, if the PRI 506-a is or is indicated via an NFR frame, a tone pattern of at least a portion of the NFR frame may correspond to an AID of the STA 104-a.

In accordance with the transmission of PRI(s) by one or more STAs 104 that have latency sensitive traffic ready for uplink transmission (such as the PRI 506-a and the PRI 506-b transmitted by the STA 104-a and the STA 104-b), the AP 102 may use the STA-specific (such as STA-identifying) signature associated with (such as collected from) each of the PRI(s) to select, identify, determine, or otherwise ascertain which STA(s) 104 have latency sensitive traffic ready for uplink transmission. For example, the AP 102 may collect information, via the reception of the PRI(s), regarding which STA(s) 104 have latency sensitive traffic and, accordingly, may better coordinate access between such STA(s) 104 thereafter (such as to provide sufficient resources to one or more STAs 104 in accordance with respective amounts or priorities of latency sensitive traffic at each of the various STAs 104 that sent PRIs). Additionally, or alternatively, the AP 102 may use such information (such as information relating to the reception of zero, one, or multiple PRIs and each received PRI's signature) to determine whether to further transmit PR messages. For example, if zero PRIs are received, the AP 102 may refrain from transmitting any further PR messages. Alternatively, if one or multiple PRIs are received, the AP 102 may continue transmitting further PR messages.

The AP 102 may signal which STA(s) 104 can preempt the downlink TXOP 512 or how the STA(s) 104 can preempt the downlink TXOP 512 via a PRS frame 510. The PRS frame 510 may be a frame dedicated to providing downlink TXOP preemption information (such as dedicated to providing downlink TXOP preemption information responsive to one or more PRIs) or may be a basic Trigger frame, such as a basic frame for (such as associated with) TB uplink MU OFDMA. In some implementations, including implementations in which the PRS frame 510 is a frame dedicated to providing downlink TXOP preemption information, the PRS frame 510 may include (such as indicate) preemption-contention specific parameters. The PRS frame 510 may equivalently referred to as a PRS message.

In some examples, the AP 102 may send the PRS frame 510 to allow a (sub) set of the STA(s) 104 that sent PRIs to preempt the downlink TXOP 510. In other words, the PRS frame 510 may provide (such as indicate) a down-selection of preempting STAs 104 from a set of STAs 104 that sent PRIs. The AP 102 may transmit the PRS frame 510 SIFS after the PRI(s), such as SIFS after the PRI 506-a and the PRI 506-b. The PRS frame 510 may include channel access information for the STA(s) 104 that sent PRIs. Such channel access information may include an indication of which STA(s) 104 are allowed to (attempt to) preempt the downlink TXOP 512 or how each STA 104 that is allowed to preempt can attempt to obtain channel access. In some implementations, the PRS frame 510 may grant downlink TXOP preemption permission to one or more STAs 104 that sent a PRI. For example, the PRS frame 510 may grant permission for uplink preemption of a downlink TXOP to the STA 104-a or to the STA 104-b.

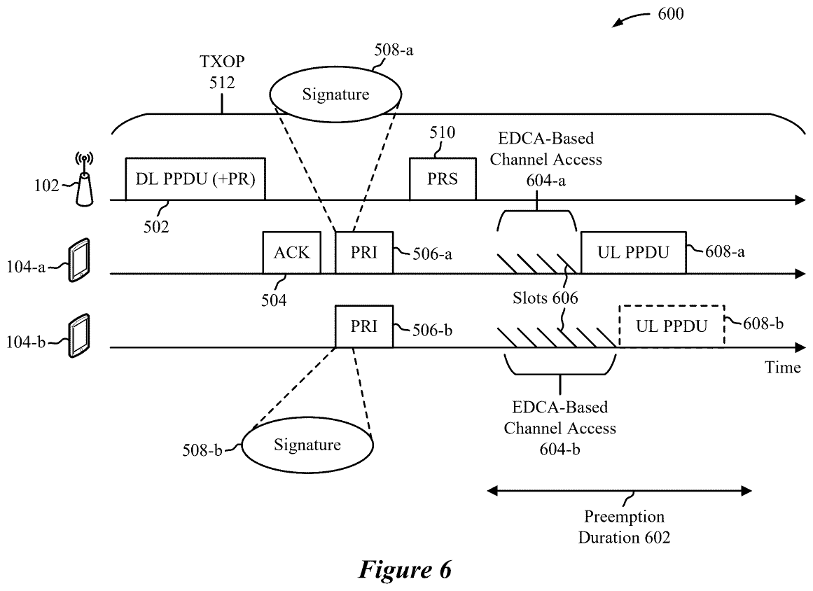

Additionally, or alternatively, the PRS frame 510 may include a subfield per STA 104 (such as a STA info subfield, a per-STA subfield, or a user info subfield). For example, the PRS frame 510 may include a first subfield (a first STA info subfield, per-STA subfield, or user info subfield) associated with the STA 104-a and a second subfield (a second STA info subfield, per-STA subfield, or user info subfield) associated with the STA 104-b. The first subfield may be associated with the STA 104-a by way of including (in an AID subfield) a first AID corresponding to the STA 104-a and the second subfield may be associated with the STA 104-b by way of including (in an AID subfield) a second AID corresponding to the STA 104-b. In such implementations, the PRS frame 510 may provide channel access information (such as permission or parameters for preemption) via each of the different subfields. For example, the first subfield may provide first channel access information (such as permission or a first set of parameters for preemption) associated with the STA 104-a and the second subfield may provide second channel access information (such as permission or a second set of parameters for preemption) associated with the STA 104-b. Such parameters for preemption may include an RU allocation or channel access parameters. For example, the PRS frame 510 may be a scheduling frame assigning RU(s) to the target STA(s) 104 that sent PRIs (such as for a TB uplink as in MU OFDMA). Additionally, or alternatively, the PRS frame 510 may be a frame dedicated to or otherwise associated with assigning access parameters to the target STA(s) 104. Such access parameters are illustrated by and described in more detail herein, including with reference to FIGS. 6-9.

In some implementations, the PRS frame 510 may omit per-STA fields and grant permission to a set of (such as all) STAs 104 that sent a PRI. In such implementations, the PRS frame 510 may convey such a grant of permission via one bit, such as via a 1-bit field or other 1-bit information included within the PRS frame 510. Further, in such implementations, the access parameter(s) may be common (such as applicable to multiple STAs 104, such as to both the STA 104-a and the STA 104-b). The PRS frame 510 may include the common access parameter(s) or may not include the common access parameter(s). In implementations in which the PRS frame 510 includes the common access parameter(s), the PRS frame 510 may include information indicative of the common access parameter(s) in a common info subfield of the PRS frame 510. In implementations in which the PRS frame 510 does not include the common access parameter(s), the AP 102 may indicate the common access parameter(s) via other (such as previous) signaling. For example, the AP 102 may transmit information indicative of the common access parameter(s) via one or more other frames, such as via a beacon frame.

In accordance with receiving the PRS frame 510, the STA 104-a and the STA 104-b may selectively contend for or access the channel according to the channel access information indicated by the PRS frame 510. For example, if the PRS frame 510 indicates that the STA 104-a is allowed to preempt the downlink TXOP 512 and that the STA 104-b is not allowed to preempt the downlink TXOP 512, the STA 104-a may contend for or access the channel to transmit an uplink data frame to the AP 102 and the STA 104-b may refrain from attempting to access the channel to transmit an uplink data frame. For further example, if the PRS frame 510 indicates that both the STA 104-a and the STA 104-b are allowed to preempt the downlink TXOP 512 and if (same or different) channel access parameters are applicable for the STA 104-a and the STA 104-b (with such parameters being indicated via the PRS frame 510 or via different signaling), both the STA 104-a and the STA 104-b may contend for or access the channel during the downlink TXOP 512 in accordance with the (same or different) channel access parameters. The channel access parameters may be associated with a given policy of channel access (such as from a set of available or possible channel access policies). Such policies relate to the different access parameters that may be indicated by the PRS frame 510 or other signaling and that apply to uplink preemption, and are illustrated by and described in more detail herein, including with reference to FIGS. 6-9.

Further, although illustrated and described in the context of a single PRS frame 510, the AP 102 may transmit any quantity of PRS frames 510. For example, the AP 102 may transmit a PRS frame 510 for each STA 104 that sent a PRI. In such examples, the AP 102 may transmit a first PRS frame 510 to the STA 104-a (in accordance with the STA 104-a transmitting the PRI 506-a) and may transmit a second PRS frame 510 to the STA 104-b (in accordance with the STA 104-b transmitting the PRI 506-b). The first PRS frame 510 may include first channel access information for the STA 104-a and the second PRS frame 510 may include second channel access information for the STA 104-b. In some examples, the AP 102 may transmit such a first PRS frame 510 SIFS after the PRIs and may transmit such a second PRS frame 510 SIFS after the first PRS frame 510 or SIFS after an uplink PPDU transmitted by the STA 104-a (which the STA 104-a may transmit SIFS after the first PRS frame 510). Additionally, or alternatively, a first PRS frame 510 may include first channel access information for a first set of one or more STAs 104 (including, for example, the STA 104-a) and a second PRS frame 510 may include second channel access information for a second set of one or more STAs 104 (including, for example, the STA 104-b). Additionally, or alternatively, if a PRS frame 510 addresses one or more STAs 104 and if a STA 104 that sent a signature-based PRI is not addressed by the PRS frame 510, the STA 104 may assume that the AP 102 has declined its request for uplink preemption or that a future PRS frame 510 may provide channel access information for the STA 104.

FIG. 6 shows an example communication timeline 600 that supports AP-aided downlink TXOP preemption by STAs with low-latency uplink traffic. The communication timeline 600 may implement or be implemented to realize one or more aspects of the wireless communication network 100, the PDU 200, the PPDU 350, the frequency diagram 400, or the signaling diagram 500. For example, the communication timeline 600 illustrates communication between an AP 102, a STA 104-a, and a STA 104-b, which may be examples of an AP 102 or a STA 104 as illustrated by or described with reference to FIGS. 1-4.

Further, the AP 102, the STA 104-a, and the STA 104-b of FIG. 6 may be examples of the AP 102, the STA 104-a, and the STA 104-b, respectively, of FIG. 5. For example, the STA 104-a may transmit a PRI 506-a associated with a signature 508-a of the STA 104-a and the STA 104-b may transmit a PRI 506-b associated with a signature 508-b of the STA 104-b. The AP 102 may transmit, responsive to the PRI 506-a and the PRI 506-b, a PRS frame 510 including channel access information for the STA 104-a and the STA 104-b, with the channel access information being associated with a downlink TXOP 512 of the AP 102. The STA 104-a and the STA 104-b may transmit the PRI 506-a and the PRI 506-b, respectively, with or without previously receiving a downlink PPDU 502 including a PR message. Moreover, the STA 104-a and the STA 104-b may transmit the PRI 506-a and the PRI 506-b, respectively, at various timings relative to the downlink PPDU 502 or an ACK 504 associated with the downlink PPDU 502, as described in more detail with reference to FIG. 5.

In some implementations, the STA 104-a and the STA 104-b may contend for or access the channel during a preemption duration 602 within the downlink TXOP 512 in accordance with an EDCA-based channel access policy. For example, a set of slots 606 may follow the PRS frame 510 and the STA 104-a and the STA 104-b may each perform EDCA-based channel access across the set of slots 606 to contend for the wireless medium (such as the channel). For example, the STA 104-a may perform EDCA-based channel access 604-a and the STA 104-b may perform EDCA-based channel access 604-b. In some example scenarios, the STA 104-a may win or otherwise obtain channel access prior to the STA 104-b (such as in accordance with superior or prioritized EDCA parameters) and may transmit an uplink PPDU 608-a (shown as “UL PPDU” in the example of FIG. 6). The uplink PPDU 608-a may include or be an example of an uplink data frame. In such example scenarios, the STA 104-b may measure or otherwise determine that the STA 104-a obtained channel access prior to the STA 104-b and may defer (such as to a later time) or drop/cancel an uplink PPDU 608-b accordingly.

In such implementations of EDCA-based channel access, the AP 102 may signal (such as provide or indicate) a set of one or more EDCA parameters to the STA 104-a and the STA 104-b beforehand (such as previously, such as via a beacon frame) or dynamically (such as via the PRS frame 510). The set of one or more EDCA parameters may be common (such as applicable) to both the STA 104-a and the STA 104-b or may include a first set of one or more EDCA parameters for the STA 104-a and a second set of one or more EDCA parameters for the STA 104-b. In some examples, the EDCA parameters may be indicated or defined per priority. For example, a first set of one or more EDCA parameters may be indicated or defined for a first priority (such as a first priority value, such as a first application type, a first QoS class, or a first UP) and a second set of one or more EDCA parameters may be indicated or defined for a second priority (such as a second priority value, such as a second application type, a second QoS class, or a second UP). In some other examples, the EDCA parameters may be equally applicable to a set of (such as all) priorities. In some aspects, parameters may be indicated or defined per priority if provided via a beacon frame, may be common if provided dynamically via the PRS frame 510, or may be indicated per-STA if the PRS frame 510 includes one or more per-STA subfields. Thus, the AP 102 may send the PRS frame 510 including information indicative of which STA(s) 104 can preempt or of access parameters (such as one or more EDCA parameters).

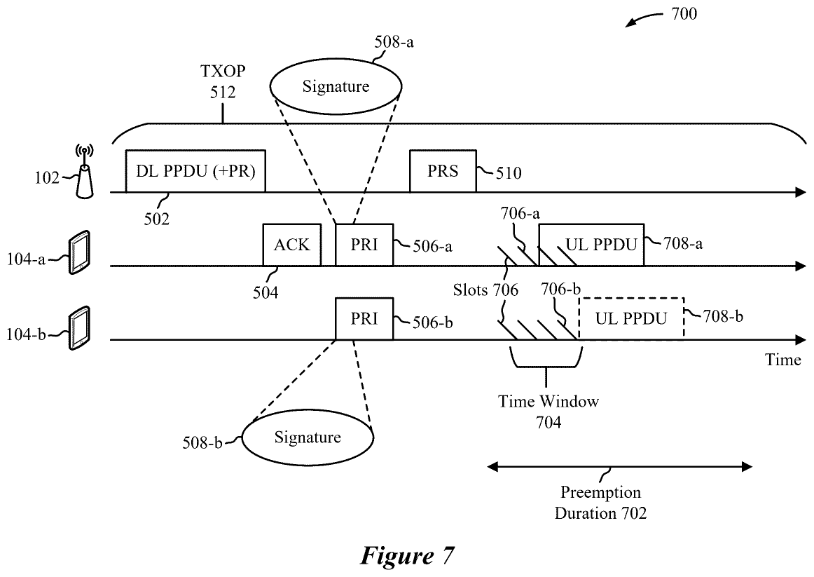

FIG. 7 shows an example communication timeline 700 that supports AP-aided downlink TXOP preemption by STAs with low-latency uplink traffic. The communication timeline 700 may implement or be implemented to realize one or more aspects of the wireless communication network 100, the PDU 200, the PPDU 350, the frequency diagram 400, or the signaling diagram 500. For example, the communication timeline 700 illustrates communication between an AP 102, a STA 104-a, and a STA 104-b, which may be examples of an AP 102 or a STA 104 as illustrated by or described with reference to FIGS. 1-4.

Further, the AP 102, the STA 104-a, and the STA 104-b of FIG. 7 may be examples of the AP 102, the STA 104-a, and the STA 104-b, respectively, of FIG. 5. For example, the STA 104-a may transmit a PRI 506-a associated with a signature 508-a of the STA 104-a and the STA 104-b may transmit a PRI 506-b associated with a signature 508-b of the STA 104-b. The AP 102 may transmit, responsive to the PRI 506-a and the PRI 506-b, a PRS frame 510 including channel access information for the STA 104-a and the STA 104-b, with the channel access information being associated with a downlink TXOP 512 of the AP 102. The STA 104-a and the STA 104-b may transmit the PRI 506-a and the PRI 506-b, respectively, with or without previously receiving a downlink PPDU 502 including a PR message. Moreover, the STA 104-a and the STA 104-b may transmit the PRI 506-a and the PRI 506-b, respectively, at various timings relative to the downlink PPDU 502 or an ACK 504 associated with the downlink PPDU 502, as described in more detail with reference to FIG. 5.

In some implementations, the STA 104-a and the STA 104-b may contend for or access the channel during a preemption duration 702 within the downlink TXOP 512 in accordance with a window-based, such as a fixed window-based, channel access policy. For example, the preemption duration 702 may include a time window 704 that includes a set of slots 706 and a STA 104 may hash to a position (such as a slot) within the time window 704 and attempt to transmit an uplink data frame at the position to which the STA 104 hashes. For example, the STA 104-a may hash to a slot 706-a and transmit an uplink PPDU 708-a starting from the slot 706-a. The STA 104-b may hash to a slot 706-b and attempt to transmit an uplink PPDU 708-b. In some example scenarios, the slot 706-a may occur prior to the slot 706-b and the uplink PPDU 708-a may be ongoing during the slot 706-b. In such example scenarios, the STA 104-b may defer (such as to a later time) or drop/cancel an uplink PPDU 708-b accordingly. In other words, a STA 104 may select (and hash to) a slot in the time window 704, sense the channel in one or more slots prior to the selected slot, and transmit in the selected slot if the channel is sensed to be clear. In other words, STAs 104 that receive the PRS frame 510 sense one or more slots prior to the selected slot, which may be understood as hashing to the selected slot.

A STA 104 may select a slot (such as a position within the time window 704) in accordance with one or more of various criteria. In some implementations, a STA 104 may randomly select a slot from the set of slots 706 within the time window 704. Additionally, or alternatively, a STA 104 may select a slot in accordance with a set of priorities. In such implementations, different positions within the time window 704 may be related to (such as mapped to) different priorities of a set of priorities. For example, a first (such as earliest) set of one or more slots of the time window 704 may map to a highest priority, a next set of one or more slots of the time window 704 may map to a second highest priority, and so on. Such priorities may be a set of priorities for low-latency traffic or UP associated with uplink preemption and may be different from (such as defined separately from) ACs.

Additionally, or alternatively, a STA 104 may select a slot in accordance with an assignment by the AP 102. For example, the AP 102 may transmit an indication of one or more slot assignments via the PRS frame 510. In other words, the AP 102 may assign slot positions within the time window 704 per-STA in the PRS frame 510. The AP 102 may make (such as select) such slot assignment(s) on a round robin basis, per priority, or in accordance with a buffer status report (BSR) of each STA 104. In such examples, the AP 102 may transmit an indication of the slot 706-a via a first subfield of the PRS frame 510 associated with the STA 104-a and may transmit an indication of the slot 706-b via a second subfield of the PRS frame 510 associated with the STA 104-b. Additionally, or alternatively, a STA 104 may compute (such as calculate, select, determine, or otherwise identify) a slot within the time window 704 and may select the computed slot. In such implementations, a STA 104 may start at an initial position (such as an initial slot) and advance from the initial position (such as to move closer to the beginning of the time window 704) for each failed attempt of prioritizing a TXOP, and may reset when prioritization is successful. The initial position may be provided by the AP 102 via a beacon frame, the PRS frame 510, or may be determined based on low-latency traffic priority. In other words, the hashed slot may be provided for each STA 104 by the AP 102 (via the PRS frame 510 or another frame, such as a beacon frame) or may be selected autonomously by each STA 104.

The time window 704 may be associated with a length (such as a window size) K. In some aspects, K may denote a quantity of slots, such as a quantity of the set of slots 706. K slots in the preemption duration 702 (such as the preemption window), or the window size K, may be a parameter indicated by the AP 102 beforehand (such as previously, such as via a beacon frame) or dynamically (such as via the PRS frame 510). In other words, the AP 102 may transmit an indication of the value of K via the PRS frame 510 or another frame (such as a beacon frame). Thus, the AP 102 may transmit the PRS frame 510 including information indicative of which STA(s) 104 can preempt or of access parameters (such as the window size K, an order of preempting STAs 104, or an assigned slot).

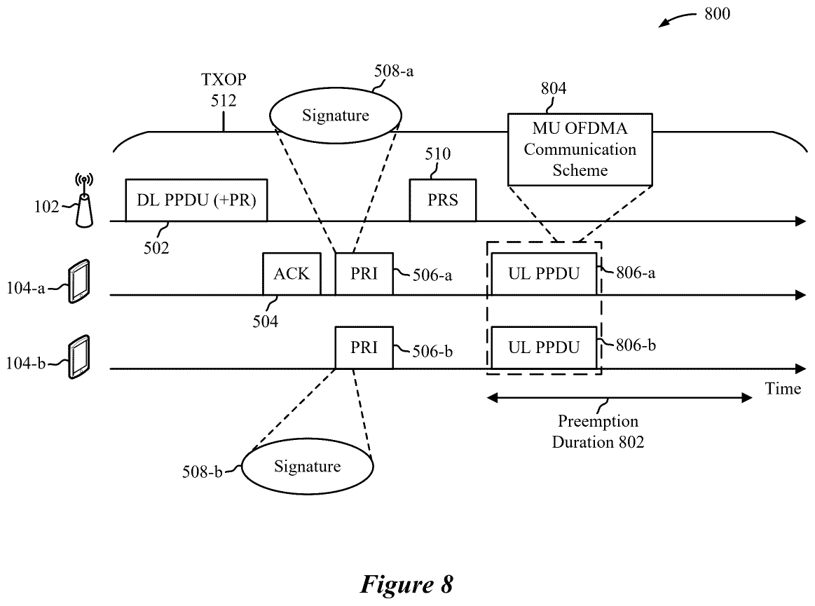

FIG. 8 shows an example communication timeline 800 that supports AP-aided downlink TXOP preemption by STAs with low-latency uplink traffic. The communication timeline 800 may implement or be implemented to realize one or more aspects of the wireless communication network 100, the PDU 200, the PPDU 350, the frequency diagram 400, or the signaling diagram 500. For example, the communication timeline 800 illustrates communication between an AP 102, a STA 104-a, and a STA 104-b, which may be examples of an AP 102 or a STA 104 as illustrated by or described with reference to FIGS. 1-4.

Further, the AP 102, the STA 104-a, and the STA 104-b of FIG. 8 may be examples of the AP 102, the STA 104-a, and the STA 104-b, respectively, of FIG. 5. For example, the STA 104-a may transmit a PRI 506-a associated with a signature 508-a of the STA 104-a and the STA 104-b may transmit a PRI 506-b associated with a signature 508-b of the STA 104-b. The AP 102 may transmit, responsive to the PRI 506-a and the PRI 506-b, a PRS frame 510 including channel access information for the STA 104-a and the STA 104-b, with the channel access information being associated with a downlink TXOP 512 of the AP 102. The STA 104-a and the STA 104-b may transmit the PRI 506-a and the PRI 506-b, respectively, with or without previously receiving a downlink PPDU 502 including a PR message. Moreover, the STA 104-a and the STA 104-b may transmit the PRI 506-a and the PRI 506-b, respectively, at various timings relative to the downlink PPDU 502 or an ACK 504 associated with the downlink PPDU 502, as described in more detail with reference to FIG. 5.

In some implementations, the STA 104-a and the STA 104-b may contend for or access the channel during a preemption duration 802 within the downlink TXOP 512 in accordance with a channel access policy associated with fixed-time scheduling by the AP 102. For example, the PRS frame 510 may include information indicative of which STA(s) 104 can preempt the downlink TXOP 512 or of access parameters (such as an indication of the preemption duration 802 and assigned/allocated RU(s)).

In some examples, the AP 102 may trigger uplink MU OFDMA with the PRS frame 510 (such as a basic frame for TB uplink MU OFDMA). For example, in accordance with the PRS frame 510 indicating an assignment (such as allocation) of one or more RUs to each of the STA 104-a and the STA 104-b, the STA 104-a and the STA 104-b may transmit uplink data frames in accordance with an MU OFDMA communication scheme 804. By indicating such RU assignments, the PRS frame 510 may be understood as indicating information associated with the MU OFDMA communication scheme 804. In accordance with the MU OFDMA communication scheme 804, the STA 104-a may transmit an uplink PPDU 806-a (a first uplink data frame) via a first set of one or more RUs and the STA 104-b may transmit an uplink PPDU 806-b (a second uplink data frame) via a second set of one or more RUs. In other words, the STA 104-a and the STA 104-b may transmit concurrently in OFDMA (with different RUs provided or indicated for different STAs 104 by the PRS frame 510).

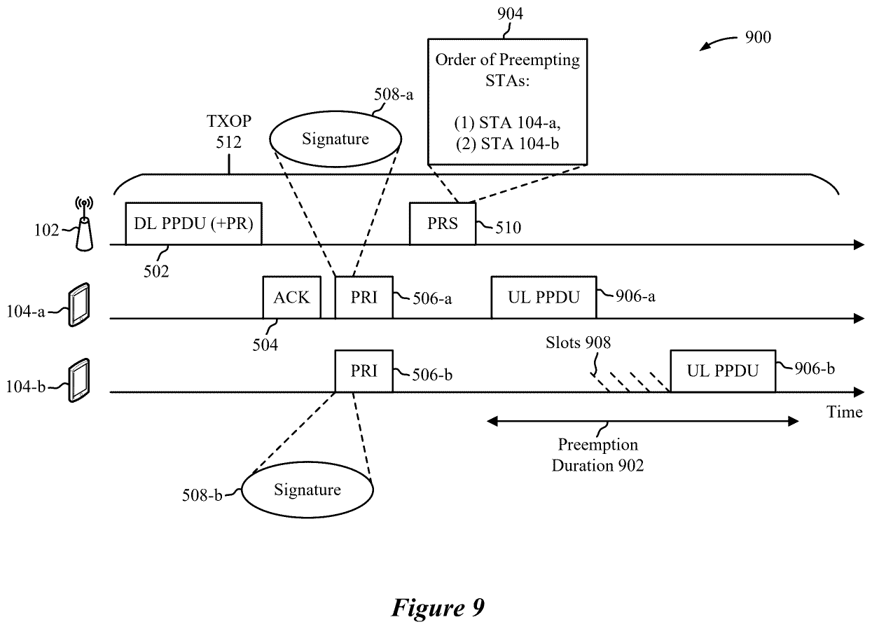

FIG. 9 shows an example communication timeline 900 that supports AP-aided downlink TXOP preemption by STAs with low-latency uplink traffic. The communication timeline 900 may implement or be implemented to realize one or more aspects of the wireless communication network 100, the PDU 200, the PPDU 350, the frequency diagram 400, or the signaling diagram 500. For example, the communication timeline 900 illustrates communication between an AP 102, a STA 104-a, and a STA 104-b, which may be examples of an AP 102 or a STA 104 as illustrated by or described with reference to FIGS. 1-4.

Further, the AP 102, the STA 104-a, and the STA 104-b of FIG. 9 may be examples of the AP 102, the STA 104-a, and the STA 104-b, respectively, of FIG. 5. For example, the STA 104-a may transmit a PRI 506-a associated with a signature 508-a of the STA 104-a and the STA 104-b may transmit a PRI 506-b associated with a signature 508-b of the STA 104-b. The AP 102 may transmit, responsive to the PRI 506-a and the PRI 506-b, a PRS frame 510 including channel access information for the STA 104-a and the STA 104-b, with the channel access information being associated with a downlink TXOP 512 of the AP 102. The STA 104-a and the STA 104-b may transmit the PRI 506-a and the PRI 506-b, respectively, with or without previously receiving a downlink PPDU 502 including a PR message. Moreover, the STA 104-a and the STA 104-b may transmit the PRI 506-a and the PRI 506-b, respectively, at various timings relative to the downlink PPDU 502 or an ACK 504 associated with the downlink PPDU 502, as described in more detail with reference to FIG. 5.

In some implementations, the STA 104-a and the STA 104-b may contend for or access the channel during a preemption duration 902 within the downlink TXOP 512 in accordance with a channel access policy associated with fixed-time scheduling by the AP 102. For example, the AP 102 may schedule the PRI-transmitting STAs 104 in accordance with a TDM communication scheme. In such examples, the AP 102 may provide, via the PRS frame 510, information indicative of an order 904 of preempting STAs 104 (such as an order 904 of the STAs 104 that transmitted signature-based PRIs). Thus, the PRS frame 510 may include information indicative of which STA(s) 104 can preempt the downlink TXOP 512 and of access parameters (such as an indication of the preemption duration 902 and a scheduling order, such as the order 904). In some implementations, the order 904 may be on a STA-by-STA basis. In some other implementations, the order 904 may be on a group of STAs-by-group of STAs basis. In such implementations, any STA of a given group of STAs may contend for channel access once that group of STAs is allowed to contend for channel access (in accordance with the order 904).

In some examples scenarios, the order 904 may indicate that the STA 104-a is expected to transmit first and that the STA 104-b is expected to transmit after the STA 104-a. In some implementations, the STA 104 that is scheduled to transmit first (such as the STA 104-a) may respond SIFS after the PRS frame 510 and other STA(s) 104 may respond after (such as in order up to a maximum or upper limit of the preemption duration 902 of the downlink TXOP 512). For example, the STA 104-a may transmit an uplink PPDU 906-a SIFS after the PRS frame 510 and the STA 104-b may transmit an uplink PPDU 906-b after the uplink PPDU 906-a.

In some implementations, the other STA(s) 104 (such as any STA 104 that is not the firstly ordered STA per the order 904, including the STA 104-b) may start EDCA-based channel access to respond (such as to transmit the uplink PPDU 906-a) opportunistically after the end of the transmission by the first STA 104 (such as the STA 104-a). In such implementations, the STA 104-b may perform an EDCA procedure during or across a set of slots 908 and may transmit the uplink PPDU 906-b upon successful channel access in accordance with the EDCA procedure. In other words, the STA 104-b may perform EDCA so that the STA 104-b can access the channel after the STA 104-a finishes transmitting. Such an EDCA procedure may be performed similarly to EDCA-based channel access 604-a or EDCA-based channel access 604-b as illustrated by and described with reference to FIG. 6. Thus, each STA 104 may use EDCA to determine where the previous STA 104 finishes transmitting, with an indication of an order or access parameters from the AP 102. Such a channel access policy may provide epsilon improvement to handle more STAs 104 in a preemption instance (instead of iterating the same sequence).

Additionally, or alternatively, the other STA(s) 104 may monitor for the header of another STA 104 to understand (such as identify, ascertain, or receive an indication of) a transmission end time and may respond (in order) SIFS after the previous STA 104. In such implementations, for example, the STA 104-b may monitor one or more frame headers to identify when the STA 104-a transmits and to identify an end of the uplink PPDU 906-a transmitted by the STA 104-a. Accordingly, the STA 104-b may transmit the uplink PPDU 906-b SIFS after the end of the uplink PPDU 906-a (per the order 904, which indicates that the STA 104-b is to transmit after the STA 104-a). The STA 104-b may identify when the STA 104-a transmits via, for example, a transmitter address (TA) or other STA-identifying information in the uplink PPDU 906-a. For example, the STA 104-b may monitor and parse a PHY header of the uplink PPDU 906-a to determine that the uplink PPDU 906-a is transmitted by the STA 104-a or to identify an end of the uplink PPDU 906-a. In other words, each STA 104 may monitor where the previous STA's transmission will end such that the preempting STAs 104 transmit in accordance with the order 904 without performing EDCA-based channel access. Such a channel access policy may provide epsilon improvement to handle more STAs 104 in a preemption instance (instead of replicating the same sequence). Further, although the order 904 is indicated by the PRS frame 510 in the example of FIG. 9, the order 904 may be implicitly indicated or may be associated with a rule configured at the AP 102 and each of the STAs 104.

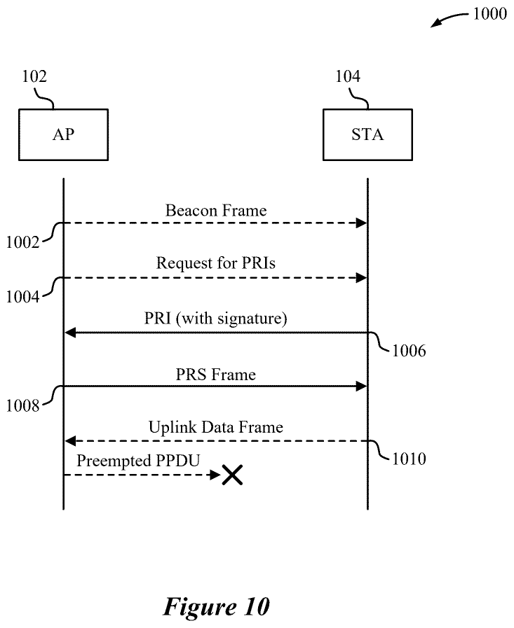

FIG. 10 shows an example process flow 1000 that supports AP-aided downlink TXOP preemption by STAs with low-latency uplink traffic. The process flow 1000 may implement or be implemented to realize one or more aspects of the wireless communication network 100, the PDU 200, the PPDU 350, the frequency diagram 400, the signaling diagram 500, or any one or more of the communication timelines 600, 700, 800, or 900. For example, the process flow 1000 illustrates communication between an AP 102 and a STA 104-a, which may be examples of an AP 102 or a STA 104 as illustrated by or described with reference to FIGS. 1-9.

In the following description of process flow 1000, the operations between the AP 102 and the STA 104 may be performed in a different order than the order shown, or other operations may be added or removed from the process flow 1000. For example, some operations also may be left out of process flow 1000, or may be performed in different orders or at different times. Further, although some operations or signaling may be shown to occur at different times for discussion purposes, these operations may actually occur at the same time. Although the AP 102 and the STA 104 are shown performing the operations of process flow 1000, some aspects of some operations also may be performed by one or more other wireless communication devices.

At 1002, the AP 102 may transmit, to the STA 104, a beacon frame. In some implementations, the AP 102 may include some amount of channel access information associated with uplink preemption in the beacon frame, such as one or more channel access parameters that the STA 104 may use to attempt to obtain channel access during a downlink TXOP of the AP 102. In some implementations, the STA 104 may reference back to the channel access information provided via the beacon frame in accordance with receiving permission to attempt to preempt the downlink TXOP of the AP 102. Further, although illustrated and described in the context of channel access information being provided by a beacon frame, the AP 102 may transmit channel access information associated with uplink preemption of a downlink TXOP via any other type of data or management frame.

At 1004, the AP 102 may transmit, to the STA 104, a request for PRIs. For example, the AP 102 may transmit a PR message (such as via an NFRP frame within a downlink PPDU) that functions as a request for a PRI from STAs 104 that have latency sensitive traffic ready for uplink transmission. In some aspects, the STA 104 may receive the request for PRIs via a downlink PPDU that is intended for (such as addressed to) a different STA 104. In such aspects, the AP 102 may convey the request via any PPDU, including PPDUs intended for a specific receiver, although the request may generally be for (such as applicable to) all STAs 104 able to receive and decode at least a portion (such as a PHY or MAC header portion) associated with the PPDU.

At 1006, the STA 104 may transmit, to the AP 102, a PRI associated with a signature of the STA 104. The signature of the STA 104 may be associated with a resource allocation via which the STA 104 transmits at least a portion of the PRI. For example, the signature of the STA 104 may be a tone pattern specific to the STA 104 (such that the tone pattern uniquely identifies or corresponds to the STA 104) and the STA 104 may transmit a portion, such as a preamble portion, of the PRI using the tone pattern. In some implementations, the STA 104 may transmit an LTF field portion of the preamble of the PRI using the tone pattern. In some implementations, the STA 104 may preempt a downlink PPDU from the AP 102 in accordance with transmitting the PRI.

At 1008, the AP 102 may transmit, to the STA 104 and in accordance with the PRI from the STA 104 being associated with the signature of the STA 104, a PRS frame. The PRS frame may include channel access information, for the STA 104, associated with a downlink TXOP of the AP 102. In some implementations, the channel access information may include an indication of whether the STA 104 is allowed to preempt the downlink TXOP. Additionally, or alternatively, the channel access information may include an indication of one or more access parameters, such as the access parameters illustrated by or described herein, including with reference to FIGS. 6-9. In some implementations, the AP 102 may transmit the PRS frame instead of a downlink PPDU in accordance with reception of the PRI at 1006. In other words, the AP 102 may delay the downlink PPDU to a later time in accordance with reception of the PRI at 1006 and may let the STA 104 potentially preempt the downlink PPDU in accordance with the information provided by the PRS frame.

At 1010, the STA 104 may transmit, to the AP 102 and during the downlink TXOP of the AP 102, an uplink data frame in accordance with the channel access information. Such an uplink data frame may be an example of, include, or be included within an uplink PPDU. For example, if the PRS frame indicates that the STA 104 is allowed to attempt to preempt the downlink TXOP, and if an attempt by the STA 104 to preempt the downlink TXOP is successful, the STA 104 may transmit the uplink data frame during the downlink TXOP of the AP 102. The STA 104 may attempt to preempt the downlink TXOP in accordance with one or more of various channel access policies, as illustrated by and described herein, including with reference to FIGS. 6-9. In some implementations, the STA 104 may preempt a downlink PPDU from the AP 102 in accordance with transmitting the uplink data frame at 1010. For example, the beacon frame received at 1002 or the PRS frame received at 1008 may indicate channel access or preemption information for the STA 104 and the STA 104 may preempt an ongoing transmission by the AP 102 (or by another wireless communication device using the downlink TXOP of the AP 102) in accordance with the information received from (such as announced by) the beacon frame or the PRS frame.

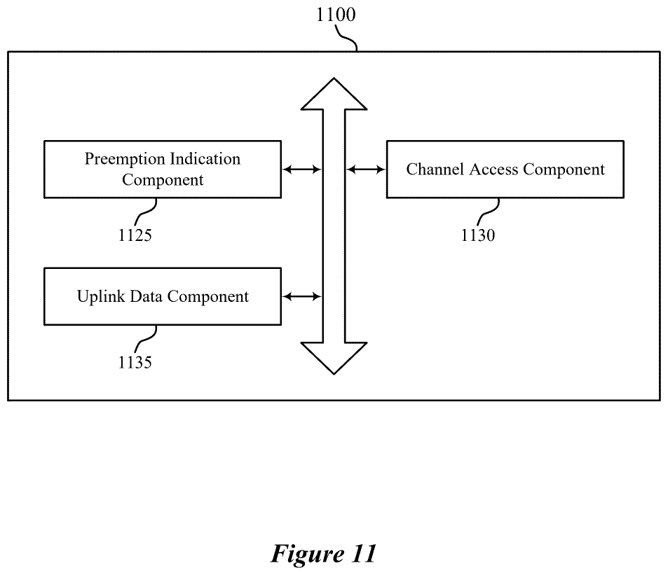

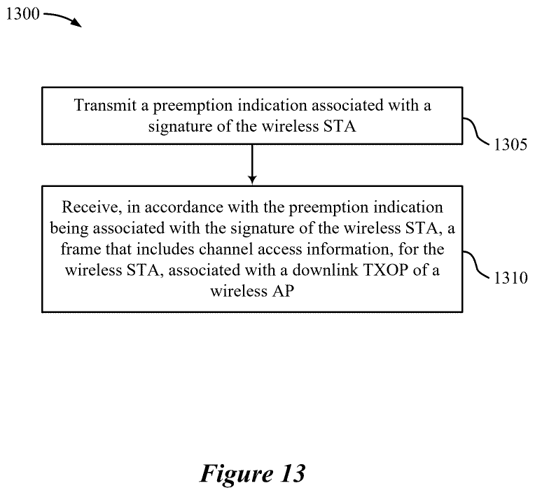

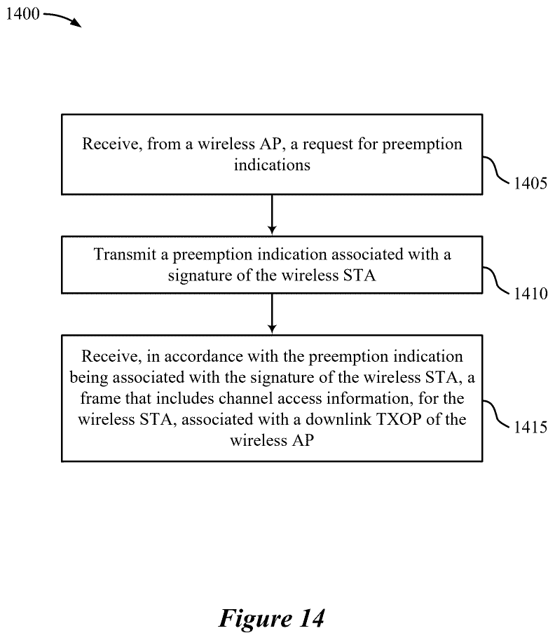

FIG. 11 shows a block diagram of an example wireless communication device 1100 that supports AP-aided downlink TXOP preemption by STAs with low-latency uplink traffic. In some examples, the wireless communication device 1100 is configured to perform the processes 1300 and 1400 described with reference to FIGS. 13 and 14, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in a STA, such as the STA 104 described with reference to FIG. 1. In some other examples, the wireless communication device 1100 can be a STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system.

The wireless communication device 1100 includes a preemption indication component 1125, a channel access component 1130, and an uplink data component 1135. Portions of one or more of the preemption indication component 1125, the channel access component 1130, and the uplink data component 1135 may be implemented at least in part in hardware or firmware. For example, one or more of the preemption indication component 1125, the channel access component 1130, and the uplink data component 1135 may be implemented at least in part by at least a processor or a modem. In some examples, portions of one or more of the preemption indication component 1125, the channel access component 1130, and the uplink data component 1135 may be implemented at least in part by a processor and software in the form of processor-executable code stored in memory.

The wireless communication device 1100 may support wireless communication in accordance with examples as disclosed herein. The preemption indication component 1125 is configurable or configured to transmit a preemption indication associated with a signature of the wireless STA. The channel access component 1130 is configurable or configured to receive, in accordance with the preemption indication being associated with the signature of the wireless STA, a frame that includes channel access information, for the wireless STA, associated with a downlink TXOP of a wireless AP.

In some examples, the preemption indication component 1125 is configurable or configured to transmit at least a portion of the preemption indication via a PPDU sent using a resource allocation associated with the wireless STA, where the signature of the wireless STA is included in the resource allocation.

In some examples, at least the portion of the preemption indication includes a field of a preamble of the PPDU that carries the preemption indication. In some examples, the resource allocation includes a tone pattern specific to the wireless STA.

In some examples, the preemption indication component 1125 is configurable or configured to transmit an indication of a priority value associated with uplink data at the wireless STA via the preemption indication, where the channel access information is associated with the priority value.

In some examples, the channel access information includes an indication that the wireless STA is allowed to preempt the downlink TXOP.

In some examples, the frame includes one or more STA info subfields, each respective STA info subfield of the one or more STA info subfields applicable to a respective wireless STA that transmitted a respective preemption indication associated with a respective signature. In some examples, the one or more STA info subfields include a first STA info subfield that corresponds to the wireless STA and includes the channel access information.

In some examples, the channel access information included within the first STA info subfield includes an RU allocation.

In some examples, the channel access information included within the first STA info subfield includes one or more channel access parameters.

In some examples, the frame includes a common info subfield, the common info subfield applicable to a set of wireless STAs that transmitted preemption indications associated with signatures. In some examples, the common info subfield includes the channel access information.

In some examples, the channel access component 1130 is configurable or configured to receive a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.

In some examples, the preemption indication component 1125 is configurable or configured to receive, from the wireless AP, a request for preemption indications, where transmitting the preemption indication is in association with receiving the request.

In some examples, to support receiving the request for the preemption indications, the preemption indication component 1125 is configurable or configured to receive a trigger frame that includes the request for the preemption indications.

In some examples, the trigger frame is an NFRP frame.

In some examples, the request is indicated via a downlink PPDU transmitted during the downlink TXOP that carries information addressed to a second wireless STA different from the wireless STA.

In some examples, the preemption indication is transmitted within a SIFS after the downlink PPDU.

In some examples, the preemption indication component 1125 is configurable or configured to transmit feedback associated with the downlink PPDU, where transmitting the preemption indication is further in association with transmitting the feedback.

In some examples, the preemption indication is multiplexed with the feedback.

In some examples, the preemption indication is transmitted within a SIFS after the feedback.

In some examples, the uplink data component 1135 is configurable or configured to transmit, during the downlink TXOP of the wireless AP, an uplink data frame in accordance with the channel access information.

In some examples, the channel access component 1130 is configurable or configured to receive information indicative of one or more EDCA parameters, where transmitting the uplink data frame is in association with accessing a wireless channel in accordance with the one or more EDCA parameters.

In some examples, the channel access component 1130 is configurable or configured to receive a second frame that includes the information indicative of the one or more EDCA parameters.

In some examples, the channel access information includes the information indicative of the one or more EDCA parameters.

In some examples, the channel access component 1130 is configurable or configured to receive information indicative of a size of a time window within which one or more preempting wireless STAs are allowed to transmit one or more uplink data frames, where transmitting the uplink data frame is in association with accessing a wireless channel within the time window.

In some examples, the channel access component 1130 is configurable or configured to receive a second frame that includes the information indicative of the size of the time window.

In some examples, the channel access information includes the information indicative of the size of the time window.

In some examples, the channel access component 1130 is configurable or configured to select a time slot within the time window. In some examples, the channel access component 1130 is configurable or configured to sense the wireless channel during one or more time slots prior to the time slot. In some examples, the uplink data component 1135 is configurable or configured to transmit the uplink data frame during the time slot in association with sensing the wireless channel to be clear during the one or more time slots.

In some examples, the channel access component 1130 is configurable or configured to receive, via the channel access information, information indicative of an uplink MU OFDMA communication scheme associated with one or more preempting wireless STAs including the wireless STA, where transmitting the uplink data frame is in accordance with the uplink MU OFDMA communication scheme.

In some examples, the channel access component 1130 is configurable or configured to receive, via the channel access information, information indicative of an order of one or more preempting wireless STAs including the wireless STA, where transmitting the uplink data frame is in association with accessing a wireless channel in accordance with the order of the one or more preempting wireless STAs.

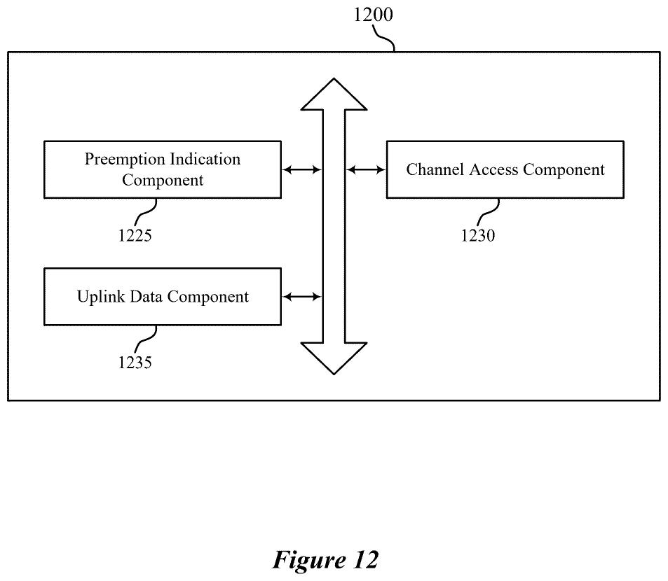

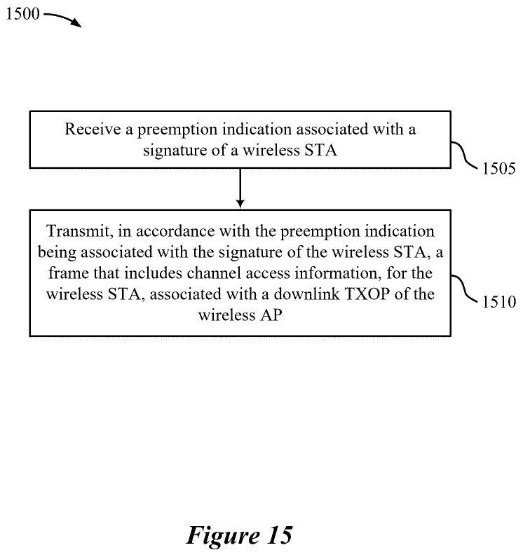

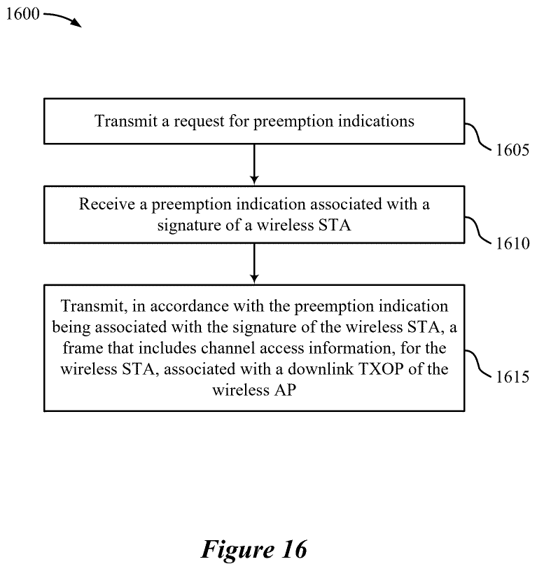

FIG. 12 shows a block diagram of an example wireless communication device 1200 that supports AP-aided downlink TXOP preemption by STAs with low-latency uplink traffic. In some examples, the wireless communication device 1200 is configured to perform the processes 1500 and 1600 described with reference to FIGS. 15 and 16, respectively. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP, such as the AP 102 described with reference to FIG. 1. In some other examples, the wireless communication device 1200 can be an AP that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a preemption indication component 1225, a channel access component 1230, and an uplink data component 1235. Portions of one or more of the preemption indication component 1225, the channel access component 1230, and the uplink data component 1235 may be implemented at least in part in hardware or firmware. For example, one or more of the preemption indication component 1225, the channel access component 1230, and the uplink data component 1235 may be implemented at least in part by at least a processor or a modem. In some examples, portions of one or more of the preemption indication component 1225, the channel access component 1230, and the uplink data component 1235 may be implemented at least in part by a processor and software in the form of processor-executable code stored in memory.

The wireless communication device 1200 may support wireless communication in accordance with examples as disclosed herein. The preemption indication component 1225 is configurable or configured to receive a preemption indication associated with a signature of a wireless STA. The channel access component 1230 is configurable or configured to transmit, in accordance with the preemption indication being associated with the signature of the wireless STA, a frame that includes channel access information, for the wireless STA, associated with a downlink TXOP of the wireless AP.

In some examples, the preemption indication component 1225 is configurable or configured to receive a set of multiple preemption indications including the preemption indication, where each respective preemption indication of the set of multiple preemption indications is associated with a respective signature of a respective wireless STA such that the set of multiple preemption indications is associated with a set of multiple signatures of a set of multiple wireless STAs including the wireless STA. In some examples, the channel access component 1230 is configurable or configured to transmit the frame that includes the channel access information in accordance with the set of multiple preemption indications being associated with the set of multiple signatures.

In some examples, the preemption indication component 1225 is configurable or configured to receive at least a portion of the preemption indication via a PPDU sent using a resource allocation associated with the wireless STA, where the signature of the wireless STA is included in the resource allocation.

In some examples, at least the portion of the preemption indication includes a field of a preamble of the PPDU that carries the preemption indication. In some examples, the resource allocation includes a tone pattern specific to the wireless STA.

In some examples, the preemption indication component 1225 is configurable or configured to receive an indication of a priority value associated with uplink data at the wireless STA via the preemption indication, where the channel access information is associated with the priority value.

In some examples, the channel access information includes an indication that the wireless STA is allowed to preempt the downlink TXOP.

In some examples, the frame includes one or more STA info subfields, each respective STA info subfield of the one or more STA info subfields applicable to a respective wireless STA that transmitted a respective preemption indication associated with a respective signature. In some examples, the one or more STA info subfields include a first STA info subfield that corresponds to the wireless STA and includes the channel access information.

In some examples, the channel access information included within the first STA info subfield includes an RU allocation.

In some examples, the channel access information included within the first STA info subfield includes one or more channel access parameters.

In some examples, the frame includes a common info subfield, the common info subfield applicable to a set of wireless STAs that transmitted preemption indications associated with signatures. In some examples, the common info subfield includes the channel access information.

In some examples, the channel access component 1230 is configurable or configured to transmit a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.

In some examples, the preemption indication component 1225 is configurable or configured to transmit a request for preemption indications, where receiving the preemption indication is in association with transmitting the request.

In some examples, to support transmitting the request for the preemption indications, the preemption indication component 1225 is configurable or configured to transmit a trigger frame that includes the request for the preemption indications.

In some examples, the trigger frame is an NFRP frame.

In some examples, the request is indicated via a downlink PPDU transmitted during the downlink TXOP that carries information addressed to a second wireless STA different from the wireless STA.

In some examples, the preemption indication is received within a SIFS after the downlink PPDU.

In some examples, the preemption indication component 1225 is configurable or configured to receive, from the wireless STA, feedback associated with the downlink PPDU, where receiving the preemption indication is further in association with receiving the feedback.

In some examples, the preemption indication is multiplexed with the feedback.

In some examples, the preemption indication is received within a SIFS after the feedback.

In some examples, the uplink data component 1235 is configurable or configured to receive, from the wireless STA and during the downlink TXOP of the wireless AP, an uplink data frame in accordance with the channel access information.

In some examples, the channel access component 1230 is configurable or configured to transmit, to the wireless STA, information indicative of one or more EDCA parameters, where receiving the uplink data frame is in accordance with the one or more EDCA parameters.

In some examples, the channel access component 1230 is configurable or configured to transmit a second frame that includes the information indicative of the one or more EDCA parameters.

In some examples, the channel access information includes the information indicative of the one or more EDCA parameters.

In some examples, the channel access component 1230 is configurable or configured to transmit information indicative of a size of a time window within which one or more preempting wireless STAs are allowed to transmit one or more uplink data frames, where receiving the uplink data frame is in accordance with the time window.

In some examples, the channel access component 1230 is configurable or configured to transmit a second frame that includes the information indicative of the size of the time window.

In some examples, the channel access information includes the information indicative of the size of the time window.

In some examples, the channel access component 1230 is configurable or configured to transmit, via the channel access information, information indicative of an uplink MU OFDMA communication scheme associated with one or more preempting wireless STAs including the wireless STA, where receiving the uplink data frame is in accordance with the uplink MU OFDMA communication scheme.

In some examples, the channel access component 1230 is configurable or configured to transmit, via the channel access information, information indicative of an order of one or more preempting wireless STAs including the wireless STA, where receiving the uplink data frame is in accordance with the order of the one or more preempting wireless STAs.

FIG. 13 shows a flowchart illustrating an example process 1300 performable by or at a wireless STA that supports AP-aided downlink TXOP preemption by STAs with low-latency uplink traffic. The operations of the process 1300 may be implemented by a wireless STA or its components as described herein. For example, the process 1300 may be performed by a wireless communication device, such as the wireless communication device 1100 described with reference to FIG. 11, operating as or within a wireless STA. In some examples, the process 1300 may be performed by a wireless STA, such as one of the STAs 104 described with reference to FIG. 1.

In some examples, in block 1305, the wireless STA may transmit a preemption indication associated with a signature of the wireless STA. The operations of block 1305 may be performed in accordance with examples as disclosed herein. In some implementations, aspects of the operations of block 1305 may be performed by a preemption indication component 1125 as described with reference to FIG. 11.

In some examples, in block 1310, the wireless STA may receive, in accordance with the preemption indication being associated with the signature of the wireless STA, a frame that includes channel access information, for the wireless STA, associated with a downlink TXOP of a wireless AP. The operations of block 1310 may be performed in accordance with examples as disclosed herein. In some implementations, aspects of the operations of block 1310 may be performed by a channel access component 1130 as described with reference to FIG. 11.

FIG. 14 shows a flowchart illustrating an example process 1400 performable by or at a wireless STA that supports AP-aided downlink TXOP preemption by STAs with low-latency uplink traffic. The operations of the process 1400 may be implemented by a wireless STA or its components as described herein. For example, the process 1400 may be performed by a wireless communication device, such as the wireless communication device 1100 described with reference to FIG. 11, operating as or within a wireless STA. In some examples, the process 1400 may be performed by a wireless STA, such as one of the STAs 104 described with reference to FIG. 1.

In some examples, in block 1405, the wireless STA may receive, from a wireless AP, a request for preemption indications. The operations of block 1405 may be performed in accordance with examples as disclosed herein. In some implementations, aspects of the operations of block 1405 may be performed by a preemption indication component 1125 as described with reference to FIG. 11.

In some examples, in block 1410, the wireless STA may transmit a preemption indication associated with a signature of the wireless STA. The operations of block 1410 may be performed in accordance with examples as disclosed herein. In some implementations, aspects of the operations of block 1410 may be performed by a preemption indication component 1125 as described with reference to FIG. 11.

In some examples, in block 1415, the wireless STA may receive, in accordance with the preemption indication being associated with the signature of the wireless STA, a frame that includes channel access information, for the wireless STA, associated with a downlink TXOP of the wireless AP. The operations of block 1415 may be performed in accordance with examples as disclosed herein. In some implementations, aspects of the operations of block 1415 may be performed by a channel access component 1130 as described with reference to FIG. 11.

FIG. 15 shows a flowchart illustrating an example process 1500 performable by or at a wireless AP that supports AP-aided downlink TXOP preemption by STAs with low-latency uplink traffic. The operations of the process 1500 may be implemented by a wireless AP or its components as described herein. For example, the process 1500 may be performed by a wireless communication device, such as the wireless communication device 1200 described with reference to FIG. 12, operating as or within a wireless AP. In some examples, the process 1500 may be performed by a wireless AP, such as one of the APs 102 described with reference to FIG. 1.

In some examples, in block 1505, the wireless AP may receive a preemption indication associated with a signature of a wireless STA. The operations of block 1505 may be performed in accordance with examples as disclosed herein. In some implementations, aspects of the operations of block 1505 may be performed by a preemption indication component 1225 as described with reference to FIG. 12.

In some examples, in block 1510, the wireless AP may transmit, in accordance with the preemption indication being associated with the signature of the wireless STA, a frame that includes channel access information, for the wireless STA, associated with a downlink TXOP of the wireless AP. The operations of block 1510 may be performed in accordance with examples as disclosed herein. In some implementations, aspects of the operations of block 1510 may be performed by a channel access component 1230 as described with reference to FIG. 12.

FIG. 16 shows a flowchart illustrating an example process 1600 performable by or at a wireless AP that supports AP-aided downlink TXOP preemption by STAs with low-latency uplink traffic. The operations of the process 1600 may be implemented by a wireless AP or its components as described herein. For example, the process 1600 may be performed by a wireless communication device, such as the wireless communication device 1200 described with reference to FIG. 12, operating as or within a wireless AP. In some examples, the process 1600 may be performed by a wireless AP, such as one of the APs 102 described with reference to FIG. 1.

In some examples, in block 1605, the wireless AP may transmit a request for preemption indications. The operations of block 1605 may be performed in accordance with examples as disclosed herein. In some implementations, aspects of the operations of block 1605 may be performed by a preemption indication component 1225 as described with reference to FIG. 12.

In some examples, in block 1610, the wireless AP may receive a preemption indication associated with a signature of a wireless STA. The operations of block 1610 may be performed in accordance with examples as disclosed herein. In some implementations, aspects of the operations of block 1610 may be performed by a preemption indication component 1225 as described with reference to FIG. 12.

In some examples, in block 1615, the wireless AP may transmit, in accordance with the preemption indication being associated with the signature of the wireless STA, a frame that includes channel access information, for the wireless STA, associated with a downlink TXOP of the wireless AP. The operations of block 1615 may be performed in accordance with examples as disclosed herein. In some implementations, aspects of the operations of block 1615 may be performed by a channel access component 1230 as described with reference to FIG. 12.

Implementation examples are described in the following numbered clauses:
Clause 1: A method for wireless communication by a wireless STA, including: transmitting a preemption indication associated with a signature of the wireless STA; and receiving, in accordance with the preemption indication being associated with the signature of the wireless STA, a frame that includes channel access information, for the wireless STA, associated with a downlink TXOP of a wireless AP.
Clause 2: The method of clause 1, further including: transmitting at least a portion of the preemption indication via a PPDU sent using the resource allocation associated with the wireless STA, where the signature of the wireless STA is included in the resource allocation.
Clause 3: The method of clause 2, where at least the portion of the preemption indication includes a field of a preamble of the PPDU that carries the preemption indication, and the resource allocation includes a tone pattern specific to the wireless STA.
Clause 4: The method of any of clauses 1-3, further including: transmitting an indication of a priority value associated with uplink data at the wireless STA via the preemption indication, where the channel access information is associated with the priority value.
Clause 5: The method of any of clauses 1-4, where the channel access information includes an indication that the wireless STA is allowed to preempt the downlink TXOP.
Clause 6: The method of any of clauses 1-5, where the frame includes one or more STA info subfields, each respective STA info subfield of the one or more STA info subfields applicable to a respective wireless STA that transmitted a respective preemption indication associated with a respective signature, and the one or more STA info subfields include a first STA info subfield that corresponds to the wireless STA and includes the channel access information.
Clause 7: The method of clause 6, where the channel access information included within the first STA info subfield includes an RU allocation.
Clause 8: The method of any of clauses 6-7, where the channel access information included within the first STA info subfield includes one or more channel access parameters.
Clause 9: The method of any of clauses 1-8, where the frame includes a common info subfield, the common info subfield applicable to a set of wireless STAs that transmitted preemption indications associated with signatures, and the common info subfield includes the channel access information.
Clause 10: The method of any of clauses 1-9, further including: receiving a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.
Clause 11: The method of any of clauses 1-10, further including: receiving, from the wireless AP, a request for preemption indications, where transmitting the preemption indication is in association with receiving the request.
Clause 12: The method of clause 11, where receiving the request for the preemption indications includes: receiving a trigger frame that includes the request for the preemption indications.
Clause 13: The method of clause 12, where the trigger frame is an NFRP frame.
Clause 14: The method of any of clauses 11-13, where the request is indicated via a downlink PPDU transmitted during the downlink TXOP that carries information addressed to a second wireless STA different from the wireless STA.
Clause 15: The method of clause 14, where the preemption indication is transmitted within a SIFS after the downlink PPDU.
Clause 16: The method of any of clauses 14-15, further including: transmitting feedback associated with the downlink PPDU, where transmitting the preemption indication is further in association with transmitting the feedback.
Clause 17: The method of clause 16, where the preemption indication is multiplexed with the feedback.
Clause 18: The method of clause 16, where the preemption indication is transmitted within a SIFS after the feedback.
Clause 19: The method of any of clauses 1-18, further including: transmitting, during the downlink TXOP of the wireless AP, an uplink data frame in accordance with the channel access information.
Clause 20: The method of clause 19, further including: receiving information indicative of one or more enhanced distributed channel access (EDCA) parameters, where transmitting the uplink data frame is in association with accessing a wireless channel in accordance with the one or more EDCA parameters.
Clause 21: The method of clause 20, further including: receiving a second frame that includes the information indicative of the one or more EDCA parameters.
Clause 22: The method of any of clauses 20-21, where the channel access information includes the information indicative of the one or more EDCA parameters.
Clause 23: The method of any of clauses 19-22, further including: receiving information indicative of a size of a time window within which one or more preempting wireless STAs are allowed to transmit one or more uplink data frames, where transmitting the uplink data frame is in association with accessing a wireless channel within the time window.
Clause 24: The method of clause 23, further including: receiving a second frame that includes the information indicative of the size of the time window.
Clause 25: The method of any of clauses 23-24, where the channel access information includes the information indicative of the size of the time window.
Clause 26: The method of any of clauses 23-25, further including: selecting a time slot within the time window; sensing the wireless channel during one or more time slots prior to the time slot; and transmitting the uplink data frame during the time slot in association with sensing the wireless channel to be clear during the one or more time slots.
Clause 27: The method of any of clauses 19-26, further including: receiving, via the channel access information, information indicative of an uplink MU OFDMA communication scheme associated with one or more preempting wireless STAs including the wireless STA, where transmitting the uplink data frame is in accordance with the uplink MU OFDMA communication scheme.
Clause 28: The method of any of clauses 19-27, further including: receiving, via the channel access information, information indicative of an order of one or more preempting wireless STAs including the wireless STA, where transmitting the uplink data frame is in association with accessing a wireless channel in accordance with the order of the one or more preempting wireless STAs.
Clause 29: A method for wireless communication by a wireless AP, including: receiving a preemption indication associated with a signature of a wireless STA; and transmitting, in accordance with the preemption indication being associated with the signature of the wireless STA, a frame that includes channel access information, for the wireless STA, associated with a downlink TXOP of the wireless AP.
Clause 30: The method of clause 29, further including: receiving a set of multiple preemption indications including the preemption indication, where each respective preemption indication of the set of multiple preemption indications is associated with a respective signature of a respective wireless STA such that the set of multiple preemption indications is associated with a set of multiple signatures of a set of multiple wireless STAs including the wireless STA; and transmitting the frame that includes the channel access information in accordance with the set of multiple preemption indications being associated with the set of multiple signatures.
Clause 31: The method of any of clauses 29-30, further including: receiving at least a portion of the preemption indication via a PPDU sent using the resource allocation associated with the wireless STA, where the signature of the wireless STA is included in the resource allocation.
Clause 32: The method of clause 31, where at least the portion of the preemption indication includes a field of a preamble of the PPDU that carries the preemption indication, and the resource allocation includes a tone pattern specific to the wireless STA.
Clause 33: The method of any of clauses 29-32, further including: receiving an indication of a priority value associated with uplink data at the wireless STA via the preemption indication, where the channel access information is associated with the priority value.
Clause 34: The method of any of clauses 29-33, where the channel access information includes an indication that the wireless STA is allowed to preempt the downlink TXOP.
Clause 35: The method of any of clauses 29-34, where the frame includes one or more STA info subfields, each respective STA info subfield of the one or more STA info subfields applicable to a respective wireless STA that transmitted a respective preemption indication associated with a respective signature, and the one or more STA info subfields include a first STA info subfield that corresponds to the wireless STA and includes the channel access information.
Clause 36: The method of clause 35, where the channel access information included within the first STA info subfield includes an RU allocation.
Clause 37: The method of any of clauses 35-36, where the channel access information included within the first STA info subfield includes one or more channel access parameters.
Clause 38: The method of any of clauses 29-37, where the frame includes a common info subfield, the common info subfield applicable to a set of wireless STAs that transmitted preemption indications associated with signatures, and the common info subfield includes the channel access information.
Clause 39: The method of any of clauses 29-38, further including: transmitting a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.
Clause 40: The method of any of clauses 29-39, further including: transmitting a request for preemption indications, where receiving the preemption indication is in association with transmitting the request.
Clause 41: The method of clause 40, where transmitting the request for the preemption indications includes: transmitting a trigger frame that includes the request for the preemption indications.
Clause 42: The method of clause 41, where the trigger frame is an NFRP frame.
Clause 43: The method of any of clauses 40-42, where the request is indicated via a downlink PPDU transmitted during the downlink TXOP that carries information addressed to a second wireless STA different from the wireless STA.
Clause 44: The method of clause 43, where the preemption indication is received within a SIFS after the downlink PPDU.
Clause 45: The method of any of clauses 43-44, further including: receiving, from the wireless STA, feedback associated with the downlink PPDU, where receiving the preemption indication is further in association with receiving the feedback.
Clause 46: The method of clause 45, where the preemption indication is multiplexed with the feedback.
Clause 47: The method of clause 45, where the preemption indication is received within a SIFS after the feedback.
Clause 48: The method of any of clauses 29-47, further including: receiving, from the wireless STA and during the downlink TXOP of the wireless AP, an uplink data frame in accordance with the channel access information.
Clause 49: The method of clause 48, further including: transmitting, to the wireless STA, information indicative of one or more EDCA parameters, where receiving the uplink data frame is in accordance with the one or more EDCA parameters.
Clause 50: The method of clause 49, further including: transmitting a second frame that includes the information indicative of the one or more EDCA parameters.
Clause 51: The method of any of clauses 49-50, where the channel access information includes the information indicative of the one or more EDCA parameters.
Clause 52: The method of any of clauses 48-51, further including: transmitting information indicative of a size of a time window within which one or more preempting wireless STAs are allowed to transmit one or more uplink data frames, where receiving the uplink data frame is in accordance with the time window.
Clause 53: The method of clause 52, further including: transmitting a second frame that includes the information indicative of the size of the time window.
Clause 54: The method of any of clauses 52-53, where the channel access information includes the information indicative of the size of the time window.
Clause 55: The method of any of clauses 48-54, further including: transmitting, via the channel access information, information indicative of an uplink MU OFDMA communication scheme associated with one or more preempting wireless STAs including the wireless STA, where receiving the uplink data frame is in accordance with the uplink MU OFDMA communication scheme.
Clause 56: The method of any of clauses 48-55, further including: transmitting, via the channel access information, information indicative of an order of one or more preempting wireless STAs including the wireless STA, where receiving the uplink data frame is in accordance with the order of the one or more preempting wireless STAs.
Clause 57: A wireless STA, including: a processing system that includes processor circuitry and memory circuitry that stores code, the processing system configured to cause the wireless STA to: transmit a preemption indication associated with a signature of the wireless STA; and receive, in accordance with the preemption indication being associated with the signature of the wireless STA, a frame that includes channel access information, for the wireless STA, associated with a downlink TXOP of a wireless AP.
Clause 58: The wireless STA of clause 57, where the processing system is further configured to cause the wireless STA to: transmit at least a portion of the preemption indication via a PPDU sent using the resource allocation associated with the wireless STA, where the signature of the wireless STA is included in the resource allocation.
Clause 59: The wireless STA of clause 58, where at least the portion of the preemption indication includes a field of a preamble of the PPDU that carries the preemption indication, and the resource allocation includes a tone pattern specific to the wireless STA.
Clause 60: The wireless STA of any of clauses 57-59, where the processing system is further configured to cause the wireless STA to: transmit an indication of a priority value associated with uplink data at the wireless STA via the preemption indication, where the channel access information is associated with the priority value.
Clause 61: The wireless STA of any of clauses 57-60, where the channel access information includes an indication that the wireless STA is allowed to preempt the downlink TXOP.
Clause 62: The wireless STA of any of clauses 57-61, where the frame includes one or more STA info subfields, each respective STA info subfield of the one or more STA info subfields applicable to a respective wireless STA that transmitted a respective preemption indication associated with a respective signature, and the one or more STA info subfields include a first STA info subfield that corresponds to the wireless STA and includes the channel access information.
Clause 63: The wireless STA of clause 62, where the channel access information included within the first STA info subfield includes an RU allocation.
Clause 64: The wireless STA of any of clauses 62-63, where the channel access information included within the first STA info subfield includes one or more channel access parameters.
Clause 65: The wireless STA of any of clauses 57-64, where the frame includes a common info subfield, the common info subfield applicable to a set of wireless STAs that transmitted preemption indications associated with signatures, and the common info subfield includes the channel access information.
Clause 66: The wireless STA of any of clauses 57-65, where the processing system is further configured to cause the wireless STA to: receive a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.
Clause 67: The wireless STA of any of clauses 57-66, where the processing system is further configured to cause the wireless STA to: receive, from the wireless AP, a request for preemption indications, where transmitting the preemption indication is in association with receiving the request.
Clause 68: The wireless STA of clause 67, where, to receive the request for the preemption indications, the processing system is configured to cause the wireless STA to: receive a trigger frame that includes the request for the preemption indications.
Clause 69: The wireless STA of clause 68, where the trigger frame is an NFRP frame.
Clause 70: The wireless STA of any of clauses 67-69, where the request is indicated via a downlink PPDU transmitted during the downlink TXOP that carries information addressed to a second wireless STA different from the wireless STA.
Clause 71: The wireless STA of clause 70, where the preemption indication is transmitted within a SIFS after the downlink PPDU.
Clause 72: The wireless STA of any of clauses 70-71, where the processing system is further configured to cause the wireless STA to: transmit feedback associated with the downlink PPDU, where transmitting the preemption indication is further in association with transmitting the feedback.
Clause 73: The wireless STA of clause 72, where the preemption indication is multiplexed with the feedback.
Clause 74: The wireless STA of clause 72, where the preemption indication is transmitted within a SIFS after the feedback.
Clause 75: The wireless STA of any of clauses 57-74, where the processing system is further configured to cause the wireless STA to: transmit, during the downlink TXOP of the wireless AP, an uplink data frame in accordance with the channel access information.
Clause 76: The wireless STA of clause 75, where the processing system is further configured to cause the wireless STA to: receive information indicative of one or more EDCA parameters, where transmitting the uplink data frame is in association with accessing a wireless channel in accordance with the one or more EDCA parameters.
Clause 77: The wireless STA of clause 76, where the processing system is further configured to cause the wireless STA to: receive a second frame that includes the information indicative of the one or more EDCA parameters.
Clause 78: The wireless STA of any of clauses 76-77, where the channel access information includes the information indicative of the one or more EDCA parameters.
Clause 79: The wireless STA of any of clauses 75-78, where the processing system is further configured to cause the wireless STA to: receive information indicative of a size of a time window within which one or more preempting wireless STAs are allowed to transmit one or more uplink data frames, where transmitting the uplink data frame is in association with accessing a wireless channel within the time window.
Clause 80: The wireless STA of clause 79, where the processing system is further configured to cause the wireless STA to: receive a second frame that includes the information indicative of the size of the time window.
Clause 81: The wireless STA of any of clauses 79-80, where the channel access information includes the information indicative of the size of the time window.
Clause 82: The wireless STA of any of clauses 79-81, where the processing system is further configured to cause the wireless STA to: select a time slot within the time window; sense the wireless channel during one or more time slots prior to the time slot; and transmit the uplink data frame during the time slot in association with sensing the wireless channel to be clear during the one or more time slots.
Clause 83: The wireless STA of any of clauses 75-82, where the processing system is further configured to cause the wireless STA to: receive, via the channel access information, information indicative of an uplink MU OFDMA communication scheme associated with one or more preempting wireless STAs including the wireless STA, where transmitting the uplink data frame is in accordance with the uplink MU OFDMA communication scheme.
Clause 84: The wireless STA of any of clauses 75-83, where the processing system is further configured to cause the wireless STA to: receive, via the channel access information, information indicative of an order of one or more preempting wireless STAs including the wireless STA, where transmitting the uplink data frame is in association with accessing a wireless channel in accordance with the order of the one or more preempting wireless STAs.
Clause 85: A wireless AP, including: a processing system that includes processor circuitry and memory circuitry that stores code, the processing system configured to cause the wireless AP to: receive a preemption indication associated with a signature of a wireless STA; and transmit, in accordance with the preemption indication being associated with the signature of the wireless STA, a frame that includes channel access information, for the wireless STA, associated with a downlink TXOP of the wireless AP.
Clause 86: The wireless AP of clause 85, where the processing system is further configured to cause the wireless AP to: receive a set of multiple preemption indications including the preemption indication, where each respective preemption indication of the set of multiple preemption indications is associated with a respective signature of a respective wireless STA such that the set of multiple preemption indications is associated with a set of multiple signatures of a set of multiple wireless STAs including the wireless STA; and transmit the frame that includes the channel access information in accordance with the set of multiple preemption indications being associated with the set of multiple signatures.
Clause 87: The wireless AP of any of clauses 85-86, where the processing system is further configured to cause the wireless AP to: receive at least a portion of the preemption indication via a PPDU sent using the resource allocation associated with the wireless STA, where the signature of the wireless STA is included in the resource allocation.
Clause 88: The wireless AP of clause 87, where at least the portion of the preemption indication includes a field of a preamble of the PPDU that carries the preemption indication, and the resource allocation includes a tone pattern specific to the wireless STA.
Clause 89: The wireless AP of any of clauses 85-88, where the processing system is further configured to cause the wireless AP to: receive an indication of a priority value associated with uplink data at the wireless STA via the preemption indication, where the channel access information is associated with the priority value.
Clause 90: The wireless AP of any of clauses 85-89, where the channel access information includes an indication that the wireless STA is allowed to preempt the downlink TXOP.
Clause 91: The wireless AP of any of clauses 85-90, where the frame includes one or more STA info subfields, each respective STA info subfield of the one or more STA info subfields applicable to a respective wireless STA that transmitted a respective preemption indication associated with a respective signature, and the one or more STA info subfields include a first STA info subfield that corresponds to the wireless STA and includes the channel access information.
Clause 92: The wireless AP of clause 91, where the channel access information included within the first STA info subfield includes an RU allocation.
Clause 93: The wireless AP of any of clauses 91-92, where the channel access information included within the first STA info subfield includes one or more channel access parameters.
Clause 94: The wireless AP of any of clauses 85-93, where the frame includes a common info subfield, the common info subfield applicable to a set of wireless STAs that transmitted preemption indications associated with signatures, and the common info subfield includes the channel access information.
Clause 95: The wireless AP of any of clauses 85-94, where the processing system is further configured to cause the wireless AP to: transmit a second frame that includes second channel access information, for the wireless STA, associated with the downlink TXOP of the wireless AP, where the channel access information included in the frame includes an indication that the wireless STA is allowed to preempt the downlink TXOP, and where the second channel access information included in the second frame includes one or more channel access parameters.
Clause 96: The wireless AP of any of clauses 85-95, where the processing system is further configured to cause the wireless AP to: transmit a request for preemption indications, where receiving the preemption indication is in association with transmitting the request.
Clause 97: The wireless AP of clause 96, where, to transmit the request for the preemption indications, the processing system is configured to cause the wireless AP to: transmit a trigger frame that includes the request for the preemption indications.
Clause 98: The wireless AP of clause 97, where the trigger frame is an NFRP frame.
Clause 99: The wireless AP of any of clauses 96-98, where the request is indicated via a downlink PPDU transmitted during the downlink TXOP that carries information addressed to a second wireless STA different from the wireless STA.
Clause 100: The wireless AP of clause 99, where the preemption indication is received within a SIFS after the downlink PPDU.
Clause 101: The wireless AP of any of clauses 99-100, where the processing system is further configured to cause the wireless AP to: receive, from the wireless STA, feedback associated with the downlink PPDU, where receiving the preemption indication is further in association with receiving the feedback.
Clause 102: The wireless AP of clause 101, where the preemption indication is multiplexed with the feedback.
Clause 103: The wireless AP of clause 101, where the preemption indication is received within a SIFS after the feedback.
Clause 104: The wireless AP of any of clauses 85-103, where the processing system is further configured to cause the wireless AP to: receive, from the wireless STA and during the downlink TXOP of the wireless AP, an uplink data frame in accordance with the channel access information.
Clause 105: The wireless AP of clause 104, where the processing system is further configured to cause the wireless AP to: transmit, to the wireless STA, information indicative of one or more EDCA parameters, where receiving the uplink data frame is in accordance with the one or more EDCA parameters.
Clause 106: The wireless AP of clause 105, where the processing system is further configured to cause the wireless AP to: transmit a second frame that includes the information indicative of the one or more EDCA parameters.
Clause 107: The wireless AP of any of clauses 105-106, where the channel access information includes the information indicative of the one or more EDCA parameters.
Clause 108: The wireless AP of any of clauses 104-107, where the processing system is further configured to cause the wireless AP to: transmit information indicative of a size of a time window within which one or more preempting wireless STAs are allowed to transmit one or more uplink data frames, where receiving the uplink data frame is in accordance with the time window.
Clause 109: The wireless AP of clause 108, where the processing system is further configured to cause the wireless AP to: transmit a second frame that includes the information indicative of the size of the time window.
Clause 110: The wireless AP of any of clauses 108-109, where the channel access information includes the information indicative of the size of the time window.
Clause 111: The wireless AP of any of clauses 104-110, where the processing system is further configured to cause the wireless AP to: transmit, via the channel access information, information indicative of an uplink MU OFDMA communication scheme associated with one or more preempting wireless STAs including the wireless STA, where receiving the uplink data frame is in accordance with the uplink MU OFDMA communication scheme.
Clause 112: The wireless AP of any of clauses 104-111, where the processing system is further configured to cause the wireless AP to: transmit, via the channel access information, information indicative of an order of one or more preempting wireless STAs including the wireless STA, where receiving the uplink data frame is in accordance with the order of the one or more preempting wireless STAs.
Clause 113: A wireless STA, including at least one means for performing a method of any of clauses 1-28.
Clause 114: A non-transitory computer-readable medium storing code for wireless communication, the code including instructions executable by a processing system to perform a method of any of clauses 1-28.
Clause 115: A wireless AP, including at least one means for performing a method of any of clauses 29-56.
Clause 116: A non-transitory computer-readable medium storing code for wireless communication, the code including instructions executable by a processing system to perform a method of any of clauses 29-56.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions. Further, “field” and “subfield” may be used interchangeably herein.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless station (STA), comprising:
a processing system that includes processor circuitry and memory circuitry that stores code, the processing system configured to cause the wireless STA to:
transmit a preemption indication associated with a signature of the wireless STA; and
receive, in accordance with the preemption indication being associated with the signature of the wireless STA, a frame that includes channel access information, for the wireless STA, associated with a downlink transmission opportunity (TXOP) of a wireless access point (AP).

2. The wireless STA of claim 1, wherein the processing system is further configured to cause the wireless STA to:
transmit at least a portion of the preemption indication via a physical layer (PHY) protocol data unit (PPDU) sent using a resource allocation associated with the wireless STA, wherein the signature of the wireless STA is comprised by the resource allocation.

3. The wireless STA of claim 2, wherein:
at least the portion of the preemption indication comprises a field of a preamble of the PPDU that carries the preemption indication; and
the resource allocation comprises a tone pattern specific to the wireless STA.

4. The wireless STA of claim 1, wherein the processing system is further configured to cause the wireless STA to:
transmit an indication of a priority value associated with uplink data at the wireless STA via the preemption indication, wherein the channel access information is associated with the priority value.

5. The wireless STA of claim 1, wherein the channel access information comprises an indication that the wireless STA is allowed to preempt the downlink TXOP.

6. The wireless STA of claim 1, wherein:
the frame includes one or more STA info subfields, each respective STA info subfield of the one or more STA info subfields applicable to a respective wireless STA that transmitted a respective preemption indication associated with a respective signature; and
the one or more STA info subfields comprise a first STA info subfield that corresponds to the wireless STA and includes the channel access information.

7. (canceled)

8. (canceled)

9. The wireless STA of claim 1, wherein:
the frame includes a common info subfield, the common info subfield applicable to a set of wireless STAs that transmitted preemption indications associated with signatures; and
the common info subfield includes the channel access information.

10. The wireless STA of claim 1, wherein the processing system is further configured to cause the wireless STA to:
receive a second frame that includes second channel access information, for the wireless STA, associated with the downlink TXOP of the wireless AP, wherein the channel access information included in the frame comprises an indication that the wireless STA is allowed to preempt the downlink TXOP, and wherein the second channel access information included in the second frame comprises one or more channel access parameters.

11. The wireless STA of claim 1, wherein the processing system is further configured to cause the wireless STA to:
receive, from the wireless AP, a request for preemption indications, wherein transmitting the preemption indication is in association with receiving the request.

12. The wireless STA of claim 11, wherein, to receive the request for the preemption indications, the processing system is configured to cause the wireless STA to:
receive a trigger frame that includes the request for the preemption indications, wherein the trigger frame is a null data packet (NDP) feedback report poll (NFRP) frame.

13. (canceled)

14. The wireless STA of claim 11, wherein the request is indicated via a downlink physical layer (PHY) protocol data unit (PPDU) transmitted during the downlink TXOP that carries information addressed to a second wireless STA different from the wireless STA.

15-28. (canceled)

29. A wireless access point (AP), comprising:
a processing system that includes processor circuitry and memory circuitry that stores code, the processing system configured to cause the wireless AP to:
receive a preemption indication associated with a signature of a wireless station (STA); and
transmit, in accordance with the preemption indication being associated with the signature of the wireless STA, a frame that includes channel access information, for the wireless STA, associated with a downlink transmission opportunity (TXOP) of the wireless AP.

30. The wireless AP of claim 29, wherein the processing system is further configured to cause the wireless AP to:
receive a plurality of preemption indications including the preemption indication, wherein each respective preemption indication of the plurality of preemption indications is associated with a respective signature of a respective wireless STA such that the plurality of preemption indications is associated with a plurality of signatures of a plurality of wireless STAs including the wireless STA; and
transmit the frame that includes the channel access information in accordance with the plurality of preemption indications being associated with the plurality of signatures.

31-39. (canceled)

40. The wireless AP of claim 29, wherein the processing system is further configured to cause the wireless AP to:
transmit a request for preemption indications, wherein receiving the preemption indication is in association with transmitting the request.

41. The wireless AP of claim 40, wherein, to transmit the request for the preemption indications, the processing system is configured to cause the wireless AP to:
transmit a trigger frame that includes the request for the preemption indications, wherein the trigger frame is a null data packet (NDP) feedback report poll (NFRP) frame.

42. (canceled)

43. The wireless AP of claim 40, wherein the request is indicated via a downlink physical layer (PHY) protocol data unit (PPDU) transmitted during the downlink TXOP that carries information addressed to a second wireless STA different from the wireless STA.

44. The wireless AP of claim 43, wherein the preemption indication is received within a short inter-frame space (SIFS) after the downlink PPDU.

45. The wireless AP of claim 43, wherein the processing system is further configured to cause the wireless AP to:
receive, from the wireless STA, feedback associated with the downlink PPDU, wherein receiving the preemption indication is further in association with receiving the feedback.

46. The wireless AP of claim 45, wherein the preemption indication is multiplexed with the feedback.

47. The wireless AP of claim 45, wherein the preemption indication is received within a short inter-frame space (SIFS) after the feedback.

48-56. (canceled)

57. A method for wireless communication by a wireless station (STA), comprising:
transmitting a preemption indication associated with a signature of the wireless STA; and
receiving, in accordance with the preemption indication being associated with the signature of the wireless STA, a frame that includes channel access information, for the wireless STA, associated with a downlink transmission opportunity (TXOP) of a wireless access point (AP).

58. The method of claim 57, further comprising:
transmitting at least a portion of the preemption indication via a physical layer (PHY) protocol data unit (PPDU) sent using a resource allocation associated with the wireless STA, wherein the signature of the wireless STA is comprised by the resource allocation, wherein at least the portion of the preemption indication comprises a field of a preamble of the PPDU that carries the preemption indication, and wherein the resource allocation comprises a tone pattern specific to the wireless STA; or
transmitting an indication of a priority value associated with uplink data at the wireless STA via the preemption indication, wherein the channel access information is associated with the priority value; or
wherein the channel access information comprises an indication that the wireless STA is allowed to preempt the downlink TXOP.

59-74. (canceled)

75. The method of claim 57, further comprising:
transmitting, during the downlink TXOP of the wireless AP, an uplink data frame in accordance with the channel access information, and wherein the method further comprises:
receiving information indicative of one or more enhanced distributed channel access (EDCA) parameters, wherein transmitting the uplink data frame is in association with accessing a wireless channel in accordance with the one or more EDCA parameters; or
receiving information indicative of a size of a time window within which one or more preempting wireless STAs are allowed to transmit one or more uplink data frames, wherein transmitting the uplink data frame is in association with accessing the wireless channel within the time window; or
receiving, via the channel access information, information indicative of an uplink multi-user (MU) orthogonal frequency division multiple access (OFDMA) communication scheme associated with one or more preempting wireless STAs including the wireless STA, wherein transmitting the uplink data frame is in accordance with the uplink MU OFDMA communication scheme; or
receiving, via the channel access information, information indicative of an order of one or more preempting wireless STAs including the wireless STA, wherein transmitting the uplink data frame is in association with accessing the wireless channel in accordance with the order of the one or more preempting wireless STAs.

76-84. (canceled)

85. A method for wireless communication by a wireless access point (AP), comprising:
receiving a preemption indication associated with a signature of a wireless station (STA); and
transmitting, in accordance with the preemption indication being associated with the signature of the wireless STA, a frame that includes channel access information, for the wireless STA, associated with a downlink transmission opportunity (TXOP) of the wireless AP.

86. (canceled)

87. The method of claim 85, further comprising:
receiving at least a portion of the preemption indication via a physical layer (PHY) protocol data unit (PPDU) sent using a resource allocation associated with the wireless STA, wherein the signature of the wireless STA is comprised by the resource allocation.

88. The method of claim 87, wherein:
at least the portion of the preemption indication comprises a field of a preamble of the PPDU that carries the preemption indication; and
the resource allocation comprises a tone pattern specific to the wireless STA.

89. (canceled)

90. The method of claim 85, wherein the channel access information comprises an indication that the wireless STA is allowed to preempt the downlink TXOP.

91-112. (canceled)
